(19) United States
(12) Patent Application Publication
(10) Pub. No.: US 2014/0218559 A1
(43) Pub. Date: Aug. 7, 2014

(54) IMAGE PICKUP APPARATUS, IMAGE PROCESSING APPARATUS, CONTROL METHOD FOR IMAGE PICKUP APPARATUS, AND IMAGE PROCESSING METHOD

(71) Applicant: CANON KABUSHIKI KAISHA, Tokyo (JP)

(72) Inventors: Shota Yamaguchi, Kawasaki-shi (JP); Naoto Kimura, Kawasaki-shi (JP)

(73) Assignee: CANON KABUSHIKI KAISHA, Tokyo (JP)

(21) Appl. No.: 14/168,646

(22) Filed: Jan. 30, 2014

(30) Foreign Application Priority Data
Feb. 7, 2013 (JP) 2013-022309

(51) Int. Cl. H04N 5/235

(52) U.S. Cl. CPC H04N 5/2352
USPC 348/229.1

(57) ABSTRACT

An image pickup apparatus capable of obtaining a natural image close to what is seen with eyes and broad in dynamic range. A plurality of object regions are determined based on image data, and representative brightness values of respective ones of the object regions are calculated. A first exposure condition is decided based on the representative brightness value of a first object region which is a main object region, and a second exposure condition is decided based on the representative brightness values of the first and second object regions. By using the first and second exposure conditions, a plurality of images for use in generating a synthesized image are acquired.

### BACKGROUND OF THE INVENTION

1. Field of the Invention

The present invention relates to an image pickup apparatus, an image processing apparatus, a control method for an image pickup apparatus, and an image processing method.

2. Description of the Related Art

Due to insufficient dynamic range of an image pickup element of an image pickup apparatus, a white spot or a black spot sometimes occurs in an image photographed by the image pickup apparatus. In a case, for example, that a person as a main object is photographed outdoor in a backlight scene, if a brightness of background sky is extremely large, a white spot occurs in a sky part of an image photographed in an exposure condition under which the person is properly photographed. The resultant output image becomes considerably different from what is seen with eyes.

To solve the above problem, there has been proposed a technique that performs photographing with an exposure amount lower than a proper exposure, and at the time of image output, performs brightness gradation conversion to obtain a brightness gradation equivalent to that obtained under proper exposure. With this technique, the brightness of an image photographed in underexposure is compressed on a high-brightness side as shown by an ellipsoidal dotted line in FIG. 25, thereby suppressing brightness saturation in a high-brightness region. The resultant image is rich in gradation and broad in dynamic range. It should be noted that in the above prior art technique, the brightness gradation conversion is collectively performed on the whole image.

FIG. 25 shows an example conversion characteristic of the brightness gradation conversion of the prior art technique. When the gradation conversion is performed with the characteristic shown in FIG. 25, an output gradation allocated to the high-brightness side becomes insufficient in some cases. This results in an output image which is low in contrast and small in brightness difference between bright and dark parts, and therefore it is not possible to sufficiently solve the aforesaid problem that the output image becomes different from what is seen with eyes.

To obviate this problem, a technique has been proposed in which in a case that exposure of a main object region is improper, two images are photographed while controlling exposures such that a main object region and a background region have appropriate brightnesses, and these two photographed images are weight-synthesized (see, Japanese Laid-open Patent Publication No. 2008-048251). Another technique has been proposed in which an image is divided into a predetermined number of blocks, and each pixel value in each block is corrected using a correction amount calculated based on a gradation conversion characteristic suitable to each block and using a weight that varies according to a distance between each pixel and the center of the block concerned, thereby obtaining an output image (see, Japanese Laid-open Patent Publication No. 2008-085634).

With the technique disclosed in Japanese Laid-open Patent Publication No. 2008-048251, however, a problem is posed that an output image which is low in contrast and small in brightness difference between bright and dark parts is generated since even if various background objects such as sky, plants, artifacts each having a specific brightness range are simultaneously present in a background region, brightness gradation conversion is collectively performed on these background objects with the same conversion characteristic.

With the technique disclosed in Japanese Laid-open Patent Publication No. 2008-085634, main and background objects such as a person and sky that are present within the angle of view are simply divided into blocks and pixel values in each block are simply corrected using an amount of pixel correction that is based on the gradation conversion characteristic suitable to each block. This makes it difficult to perform appropriate gradation control. In addition, since the amount of pixel correction is simply weighted according to the distance to the center of each block, there is a fear that an output image becomes different from what is seen with eyes.

### SUMMARY OF THE INVENTION

The present invention provides an image pickup apparatus, an image processing apparatus, a control method for an image pickup apparatus, and an image processing method that are capable of obtaining a natural image close to what is seen with eyes and broad in dynamic range.

According to one aspect of this invention, there is provided an image pickup apparatus that acquires a plurality of images for use in generating a synthesized image comprising a region determination unit configured to determine a plurality of object regions based on image data, a calculation unit configured to calculate representative brightness values of respective ones of the plurality of object regions determined by the region determination unit, a first decision unit configured to decide a first exposure condition based on the representative brightness value of a first object region calculated by the calculation unit, wherein the first object region is a main object region, a second decision unit configured to decide a second exposure condition based on the representative brightness value of the first object region and the representative brightness value of a second object region not including the first object region that are calculated by the calculation unit, wherein the second exposure condition differs from the first exposure condition, and an image acquisition unit configured to acquire a plurality of images by using the first and second exposure conditions.

With this invention, it is possible to obtain a natural image close to what is seen with eyes and broad in dynamic range.

Further features of the present invention will become apparent from the following description of exemplary embodiments with reference to the attached drawings.

### BRIEF DESCRIPTION OF THE DRAWINGS

FIG. 1A shows an example of an image photographed by an image processing apparatus according to a first embodiment;

FIGS. 1B-1D show sky, background, and person region views of the photographed image shown in FIG. 1A;

FIG. 2 is a block diagram schematically showing the construction of the image processing apparatus;

FIG. 3 is a flowchart showing procedures of a brightness calculation process executed by a region-dependent brightness calculation unit of an exposure decision unit of the image processing apparatus;

FIG. 4 shows a brightness calculation operation of the region-dependent brightness calculation unit;

FIGS. 5A-5C show a determination method used in the brightness calculation process of FIG. 3 to determine whether an AE image, which is used for deciding an exposure for each region of a photographed image, is suitable for brightness calculation;

FIG. 6 is a flowchart showing procedures of an object region determination process executed by a main object region decision unit of the exposure decision unit of the image processing apparatus;

FIG. 7 shows an evaluation value calculation process executed in the object region determination process of FIG. 6;

FIG. 8 is a flowchart showing procedures of an exposure calculation process executed by a region-dependent exposure calculation unit of the exposure decision unit of the image processing apparatus;

FIG. 9 shows an example of Bv value calculation performed in the exposure calculation process of FIG. 8;

FIG. 10 shows an operation of a signal processing unit of the image processing apparatus;

FIG. 11 is a view schematically showing an operation of an image synthesis unit of the image processing apparatus;

FIG. 12 is a block diagram schematically showing the construction of an image processing apparatus according to a second embodiment;

FIG. 13 is a flowchart showing procedures of a gain calculation process executed by a reference exposure/region-dependent gain calculation unit of a reference exposure/gain decision unit of the image processing apparatus shown in FIG. 12;

FIG. 14 is a flowchart showing procedures of a reference region decision process executed by the reference exposure/region-dependent gain calculation unit in the gain calculation process of FIG. 13;

FIG. 15 shows an example of proper Bv values for respective regions of an AE image to which is applied a brightness gradation priority method used in the reference region decision process of FIG. 14;

FIGS. 16A-16C each show an example of a Bv difference threshold value and proper Bv values for respective regions of an AE image to which is applied a low-noise priority method used in the reference region decision process of FIG. 14;

FIG. 17 shows an example of Bv values for image regions, a reference Bv value, and differences between the reference Bv value and the Bv values for the image regions in a case where a background region is selected as a reference region in the gain calculation process of FIG. 13;

FIG. 18 shows an operation of a gain processing unit of the image processing apparatus shown in FIG. 12;

FIG. 19 shows, similar to FIG. 11, an occlusion region generated in a synthesized image;

FIG. 20 is a block diagram of an image processing apparatus according to a third embodiment;

FIG. 21 is a flowchart showing procedures of a person's movement amount calculation process executed by a person's movement amount calculation unit of the image processing apparatus of FIG. 20;

FIGS. 22A and 22B show the person's movement amount calculation process (an example of FIG. 20);

FIG. 23 is a flowchart showing the procedures of a processing type determination process executed by a processing type determination unit of the image processing apparatus of FIG. 20;

FIG. 24 shows a processing type decision method used in the processing type determination process of FIG. 23; and

FIG. 25 shows an example conversion characteristic of prior art brightness gradation conversion.

### DESCRIPTION OF THE EMBODIMENTS

The present invention will now be described in detail below with reference to the drawings showing preferred embodiments thereof.

### First Embodiment

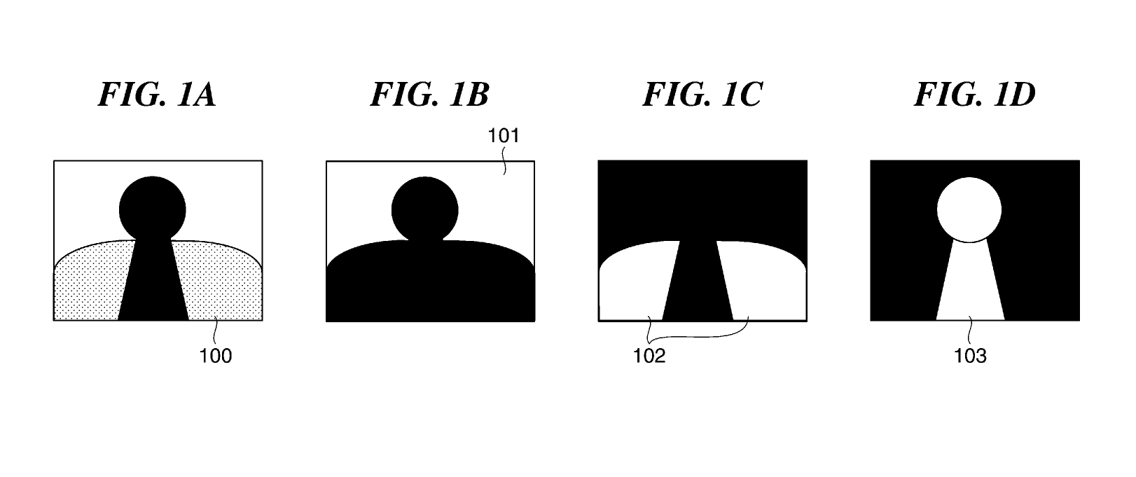

FIG. 1A shows an example of an image photographed by an image processing apparatus (e.g., image pickup apparatus) according to a first embodiment. The photographed image 100 shown in FIG. 1A is a person image (also called a human image) photographed under backlight. FIGS. 1B-1D show images 101-103 of sky, background, and person regions of the photographed image 100, which are illustrated in white.

In this embodiment, appropriate exposures for the sky, background, and person regions 101-103 into which the image 100 is divided are calculated, and processing is performed to obtain exposures appropriate for respective regions of a synthesized image. It should be noted that in a case where a person is photographed in a backlight scene, the person and background become underexposure since they are usually darker than the sky.

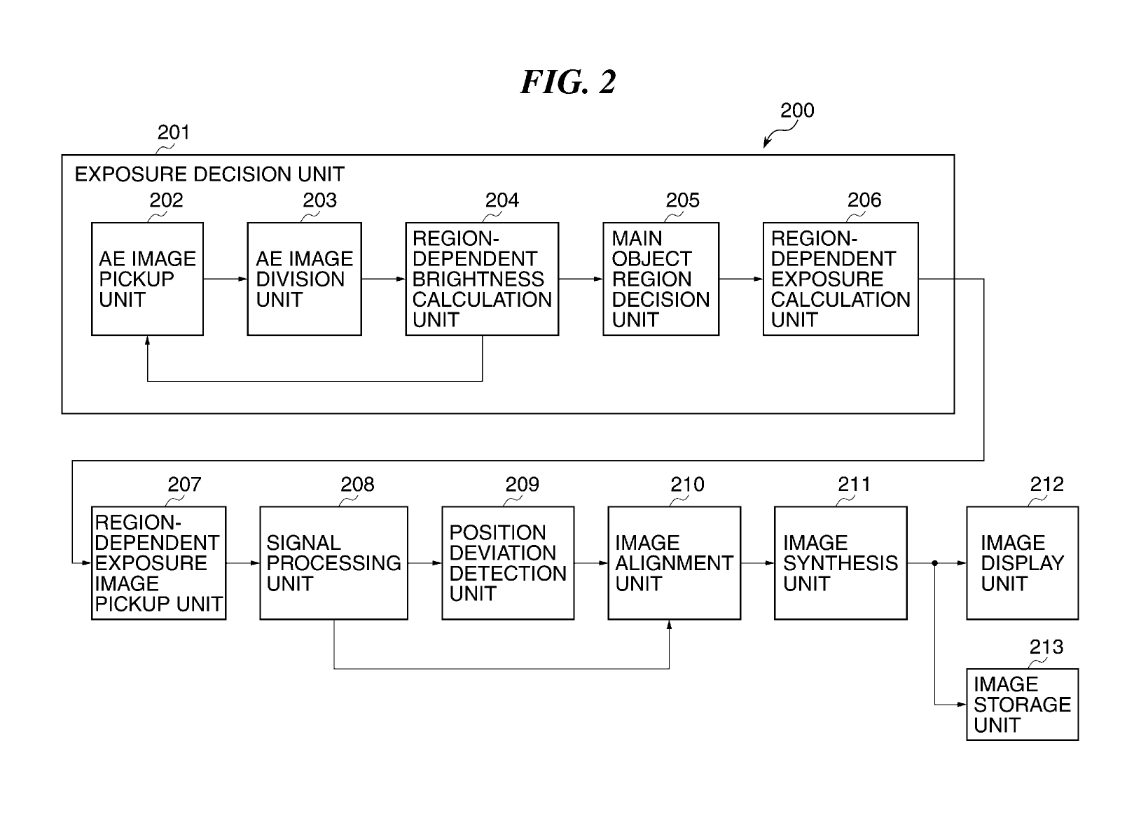

FIG. 2 shows in block diagram form the construction of the image processing apparatus of this embodiment. The image processing apparatus 200 has an exposure decision unit 201, region-dependent exposure image pickup unit 207, signal processing unit 208, position deviation detection unit 209, image alignment unit 210, image synthesis unit 211, image display unit 212, and image storage unit 213.

The exposure decision unit 201 has an AE image pickup unit 202, AE image division unit 203, region-dependent brightness calculation unit 204, main object region decision unit 205, and region-dependent exposure calculation unit 206, and decides exposures suitable to photograph respective regions (e.g., sky, background, and person regions) of an object to be photographed.

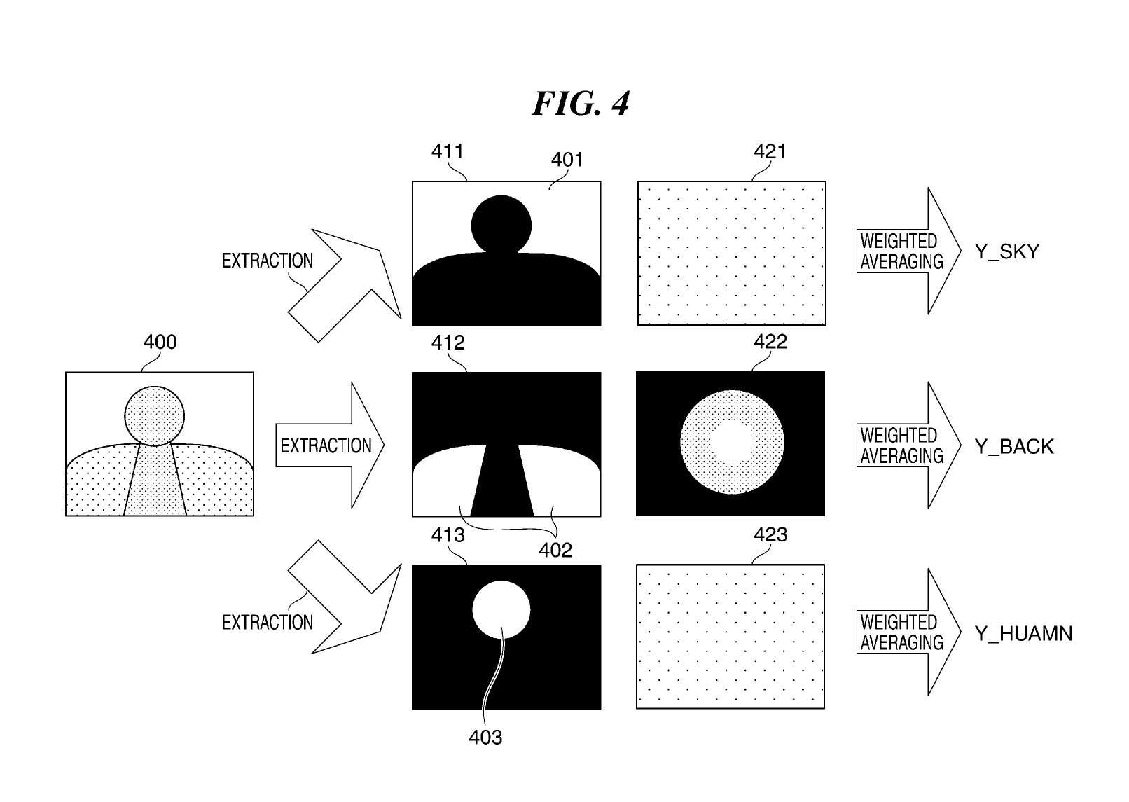

The AE image pickup unit 202 photographs and acquires an AE image used to decide exposures of respective regions of an object to be photographed. In FIG. 4, reference numeral 400 denotes an AE image.

An exposure condition (e.g., exposure value) in which an AE image is photographed is decided according to an exposure condition that is output from the region-dependent brightness calculation unit (hereinafter, referred to as the brightness calculation unit) 204. It should be noted that in an initial state where no exposure condition is output from the brightness calculation unit 204, an AE image is photographed in a default exposure condition. As the default exposure condition, there can be mentioned, by way of example, an exposure condition in which a calculated average value of brightnesses in a resultant image becomes a predetermined brightness value.

The AE image division unit 203 divides the AE image 400 into, e.g., a sky region image 401, background region image 402, and person region image 403, as shown in FIG. 4, by using an arbitrary method. As the image division method, there can be mentioned, byway of example, a method in which an image is divided into predetermined regions based on a characteristic amount and evaluation value of the image, and a method in which a neural network is used as disclosed in Japanese Laid-open Patent Publication No. 2006-039666.

The brightness calculation unit 204 reads the image regions into which the AE image is divided by the AE image division unit 203, and calculates brightnesses of these region images. If determined based on calculated brightness values of the region images that any of the region images has not been photographed with an exposure suitable for brightness calculation, the brightness calculation unit 204 outputs a new exposure value to the AE image pickup unit 202. The AE image pickup unit 202 again photographs an AE image with the new exposure value.

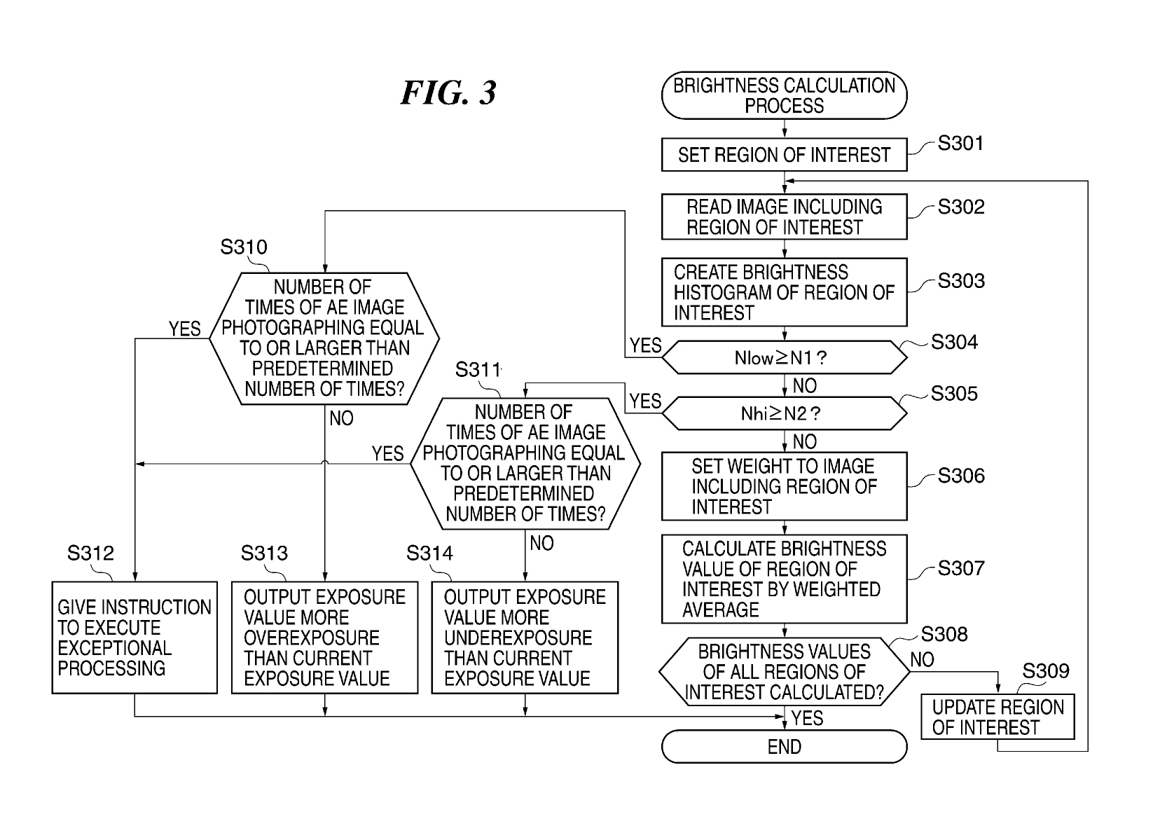

FIG. 3 shows in flowchart form the procedures of a brightness calculation process executed by the brightness calculation unit 204 of the exposure decision unit 201. FIG. 4 schematically shows a brightness calculation operation of the brightness calculation unit 204.

At start of the brightness calculation process shown in FIG. 3, the brightness calculation unit 204 sets, as a region of interest, any of sky, background, and person regions of an AE image photographed by the AE image pickup unit 202 (step S301).

Next, the brightness calculation unit 204 extracts an image of the region of interest from the AE image as shown in FIG. 4, and reads an image that includes the image of the region of interest and also includes images of other regions (step S302). In FIG. 4, reference numeral 400 denotes the AE image, and reference numerals 411-413 each denote the read image.

When the image of the region of interest is extracted from the AE image, a pixel value of 1 is set to each pixel in the region of interest and a pixel value of 0 is set to each pixel in regions other than the region of interest.

For example, when the sky region image is extracted from the AE image, a pixel value of 1 is set to each pixel of the sky region and a pixel value of 0 is set to each pixel of other regions. When the person region is extracted from the AE image, only a person's face portion is extracted. At that time, a pixel value of 1 is set to each pixel of the face portion, whereas a pixel value of 0 is set to each pixel of the neck of the person's body and body portions thereunder and to each pixel of the sky and background regions.

The region and the face portion for which a pixel value of 1 is set when the region of interest is extracted are shown in white in FIG. 4 and the region and the face portion for which a pixel value of 0 is set are shown in black in FIG. 4. It should be noted that these pixel values are used for pixel value calculation according to formula (3) and also used for evaluation value calculation according to formula (4), as will be described later.

Next, in steps S303-S305, the brightness calculation unit 204 determines whether the AE image currently processed is suitable for brightness calculation.

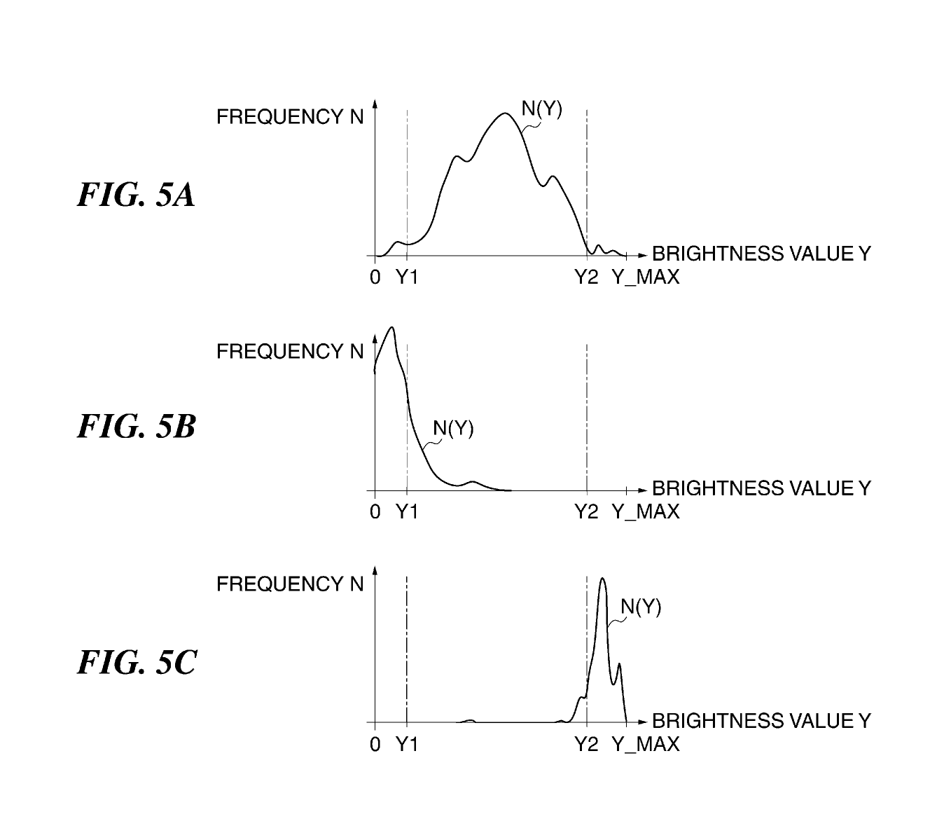

FIGS. 5A-5C each show a determination method used in steps S303-S305 to determine whether the AE image is suitable for brightness calculation.

The brightness calculation unit 204 creates a brightness histogram of the region of interest (step S303), and determines whether a brightness distribution in the created brightness histogram is deviated to either a low-brightness region or a high-brightness region (steps S304 and S305).

To this end, the brightness calculation unit 204 calculates the number of pixels, Nlow, that are contained in the low-brightness region where the brightness value Y falls in a range of 0≦Y≦Y1 shown in FIGS. 5A-5C according to formula (1) given below, and also calculates the number of pixels, Nhi, that are contained in the high-brightness region where the brightness value Y falls in a range of Y2≦Y≦Y_MAX shown in FIGS. 5A-5C according to formula (2) given below. In formulae (1) and (2), N(Y) denotes frequency N at brightness value Y in the brightness histogram.

$$\begin{matrix}Nlow = {\sum }_{Y = 0}^{Y 1} N ( Y ) & ( 1 ) \\ Nhi = {\sum }_{Y = Y 2}^{Y\_MAX} N ( Y ) & ( 2 )\end{matrix}$$

In step S304, the brightness calculation unit 204 determines whether the calculated number of pixels, Nlow, is equal to or larger than a predetermined threshold value N1. If a relation of Nlow≧N1 is satisfied (YES to step S304), i.e., if a ratio of the number of pixels, Nlow, to the total number of pixels in the image of the region of interest is large as shown in FIG. 5B, the brightness calculation unit 204 determines that the brightness distribution in the image of the region of interest is deviated to the low-brightness region and hence the AE image is not suitable for brightness calculation, and proceeds to step S310. On the other hand, if a relation of Nlow<N1 is satisfied (NO to step S304), the flow proceeds to step S305.

In step S305, the brightness calculation unit 204 determines whether or not the number of pixels, Nhi, is equal to or larger than a predetermined threshold value N2. If a relation of Nhi≧N2 is satisfied (YES to step S305), i.e., if a ratio of the number of pixels, Nhi, to the total number of pixels in the image of the region of interest is large as shown in FIG. 5C, the brightness calculation unit 204 determines that the brightness distribution in the image of the region of interest is deviated to the high-brightness region and the AE image is not suitable for brightness calculation, whereupon the flow proceeds to step S311.

If a relation of Nhi<N2 is satisfied (NO to step S305), i.e., if the ratio of the number of pixels, Nlow, to the total number of pixels in the image of the region of interest is not large and the ratio of number of pixels, Nhi, to the total number of pixels therein is not also large as shown in FIG. 5A, the brightness calculation unit 204 determines that the AE image is suitable for brightness calculation, and proceeds to step S306.

In step S306, the brightness calculation unit 204 sets a weight to the read image that includes the image of the region of interest extracted from the AE image. For example, the brightness calculation unit 204 sets a weighting image for allocating a weighting value varying from 0 to 1 to each pixel of the read image including the image of the region of interest.

In FIG. 4, reference numerals 421-423 respectively denote weighting images that correspond to the read images 411-413 including the images 401-403 of the regions of interest extracted from the AE image 400.

The weighting image 421 allocates the same weighting value to all the pixels of the read image 411 including the sky region image 401. The weighting image 422 allocates a weighting value of 1 to each pixel of a central part of the read image 412 including the background region image 402 and allocates to other pixels a weighting value that decreases with increase of a distance from the center of the read image 412. The weighting image 423 allocates the same weighting value to all the pixels of the read image 413 including the person region image (face portion) 403.

Next, in step S307, the brightness calculation unit 204 calculates a brightness value Yarea of the region of interest by weighted average according to formula (3) given below.

$$Yarea = \frac{{\sum }_{i , j} w 1 ( i , j ) w 2 ( i , j ) Y ( i , j )}{{\sum }_{i , j} w 1 ( i , j ) w 2 ( i , j )} \qquad ( 3 )$$

In formula (3), symbol w1(i, j) denotes a pixel value at a coordinate (i, j) in the read image, and the pixel value has a value of 1 in the image of the region of interest and has a value of 0 in other region images. Symbol w2(i, j) denotes a pixel value at a coordinate (i, j) in the weighting image, and Y(i, j) denotes an input brightness value at the coordinate (i, j) in the read image.

In the following, brightness values Yarea of the sky region, background region, and person region (also called human region) that are calculated in step S307 are respectively denoted by Y_SKY, Y_BACK, and Y_HUMAN (see FIG. 4).

Next, in step S308, the brightness calculation unit 204 confirms whether the brightness values Yarea of all the regions of interest have been calculated. If the brightness values of all the regions of interest have not been calculated (NO to step S308), the brightness calculation unit 204 proceeds to step S309 where the region of interest is updated, whereupon the flow returns to step S302. On the other hand, if the brightness values of all the regions of interest have been calculated (YES to step S308), the present process is completed.

If determined in step S304 that the relation of Nlow≧N1 is satisfied and the AE image is not suitable for brightness calculation, the brightness calculation unit 204 confirms whether or not the number of times of AE image photographing is equal to or larger than a predetermined number of times (step S310).

If the number of times of photographing is neither equal to nor larger than the predetermined number of times (NO to step S310), the brightness calculation unit 204 determines that the current AE image has been photographed with an exposure value that is more underexposure than a proper value, and outputs to the AE image pickup unit 202 a new exposure value which is more overexposure than the current exposure value by a predetermined value (step S313), whereupon the present process is completed.

If determined in step S305 that the relation of Nhi≧N2 is satisfied and the AE image is not suitable for brightness calculation, the brightness calculation unit 204 confirms whether the number of times of AE image photographing is equal to or larger than a predetermined number of times (step S311).

If the number of times of photographing is neither equal to nor larger than the predetermined number of times (NO to step S311), the brightness calculation unit 204 determines that the current AE image has been photographed with an exposure value which is more overexposure than a proper value, and outputs to the AE image pickup unit 202 a new exposure value which is more underexposure than the current exposure value by a predetermined value (step S314), whereupon the present process is completed.

If determined in step S310 or S311 that the number of times of photographing is equal to or larger than the predetermined number of times, the brightness calculation unit 204 gives an instruction to execute exceptional processing, e.g., strobe photographing (step S312), and completes the present process.

As described above, according to the brightness calculation process of FIG. 3, the brightness values Y_SKY, Y_BACK, and Y_HUMAN of sky, background, and person regions of the AE image are calculated by the brightness calculation unit 204, or a new exposure value for use by the AE image pickup unit 202 to again photograph the AE image is created by the brightness calculation unit 204.

Based on the brightness values of the sky, background, and person regions of the AE image calculated by the brightness calculation unit 204, the main object region decision unit 205 selects a main object region from among the sky, background, and person regions as will be described below.

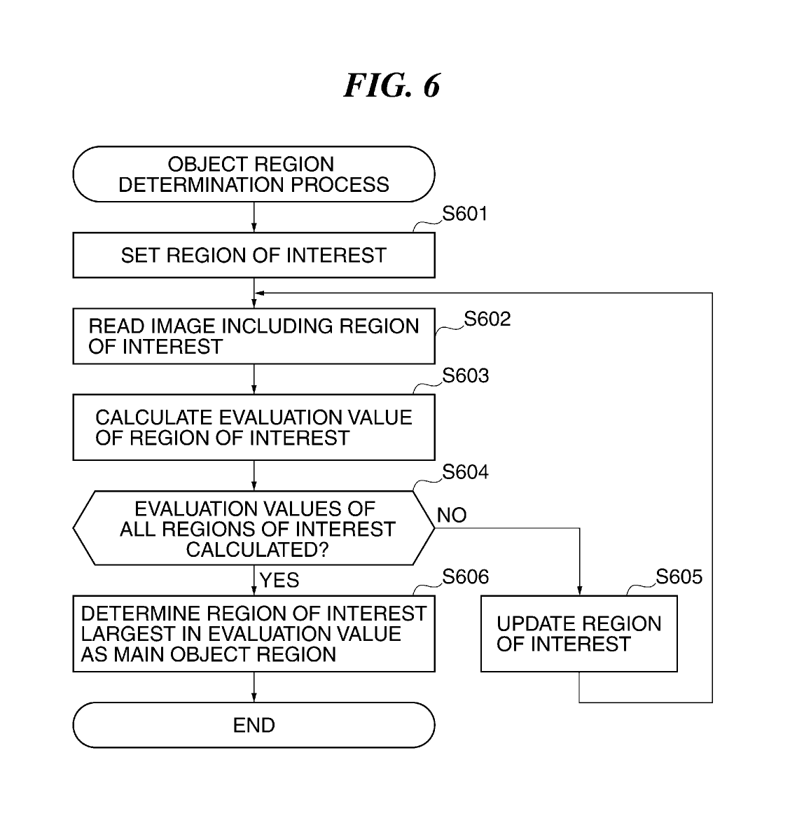

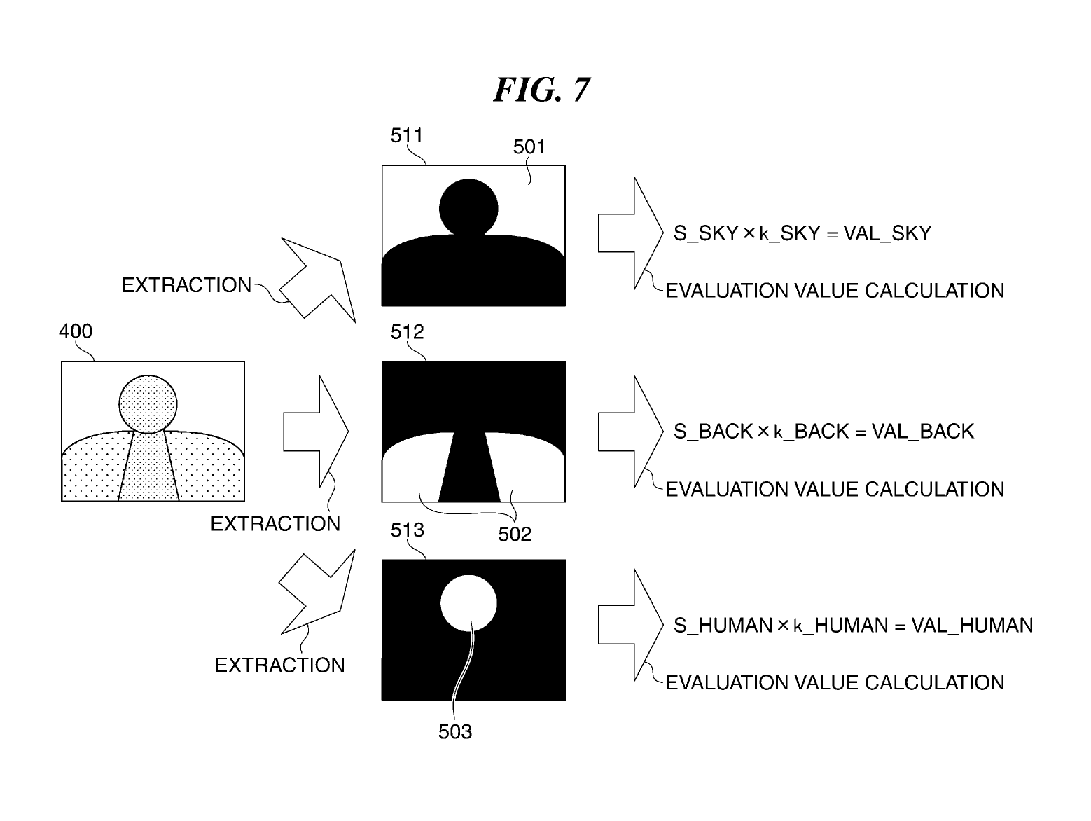

FIG. 6 shows in flowchart form the procedures of an object region determination process executed by the main object region decision unit 205. FIG. 7 schematically shows an evaluation value calculation process executed in step S603 of the object region determination process.

At start of the object region determination process of FIG. 6, the main object region decision unit 205 sets, as the region of interest, any of sky, background, and person regions of an AE image photographed by the AE image pickup unit 202 (step S601).

Next, as shown in FIG. 7, the brightness calculation unit 204 extracts an image of the region of interest set in step S601 from the AE image, and reads an image that includes the image of the region of interest and other region images (step S602).

In step S602, processing is performed that is substantially the same as that performed in step S302 of the brightness calculation process of FIG. 3. It should be noted that unlike the processing in step S302 that extracts only a person's face portion from the AE image, the whole person region image is extracted from the AE image in step S602, if the region of interest is the person region.

In FIG. 7, reference numeral 400 denotes the AE image, reference numerals 501-503 respectively denote the sky region image, background region image, and person region image, and reference numerals 511-512 denote read images.

Next, the main object region decision unit 205 calculates an evaluation value VAL of the region of interest by multiplying an area (size) S of the region of interest by a predetermined coefficient k according to formula (4) given below (step S603).

VAL=S×k=Σw1(i,j)×k (4)

In formula (4), as in formula (3), symbol w1(i, j) represents a pixel value at a coordinate (i, j) in the read image. The pixel value has a value of 1 in the image of the region of interest, and has a value of 0 in other region images. Thus, the area (size) S of the region of interest can be calculated by integrating the pixel value w1(i, j) over the entire read image. A predetermined coefficient k represents the degree of importance of the region of interest of the read image in the calculation of the evaluation value VAL. The predetermined coefficient k has a value proper to each region of interest. It should be noted that the predetermined coefficient k can be a fixed value or can be a variable that changes according to a photographic scene.

Next, the main object region decision unit 205 confirms whether the evaluation values of all the regions of interest have been calculated (step S604). If there is a region of interest whose evaluation value has not been calculated (NO to step S604), the main object region decision unit 205 updates the region of interest (step S605), and returns to step S602. On the other hand, if the evaluation values of all the regions of interest have been calculated (YES to step S604), the main object region decision unit 205 determines, as the main object region, the region of interest that is the largest in evaluation value VAL_SKY, VAL_BACK, or VAL_HUMAN among all the regions of interest, i.e., among the sky, background, and person regions (step S606), and completes the present process.

As described above, according to the object region determination process of FIG. 6, the main object region is decided by the main object region decision unit 205 from among the sky, background, and person regions of the AE image.

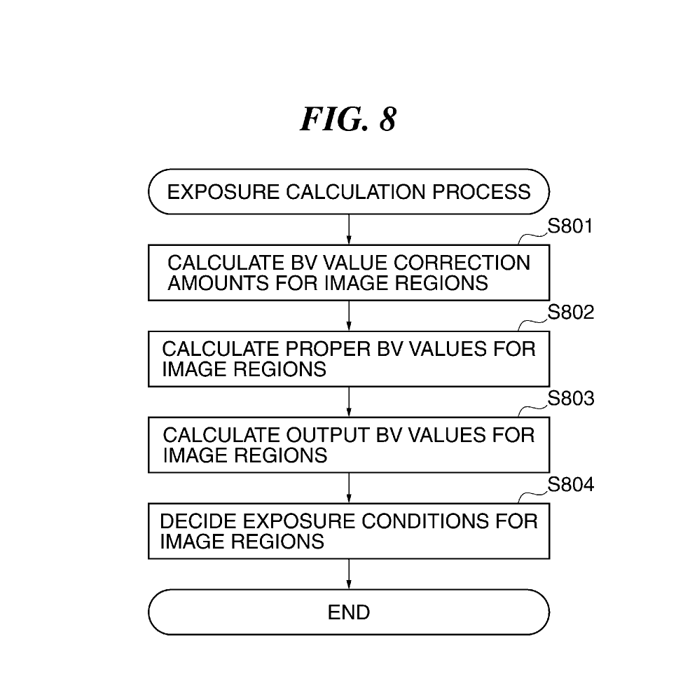

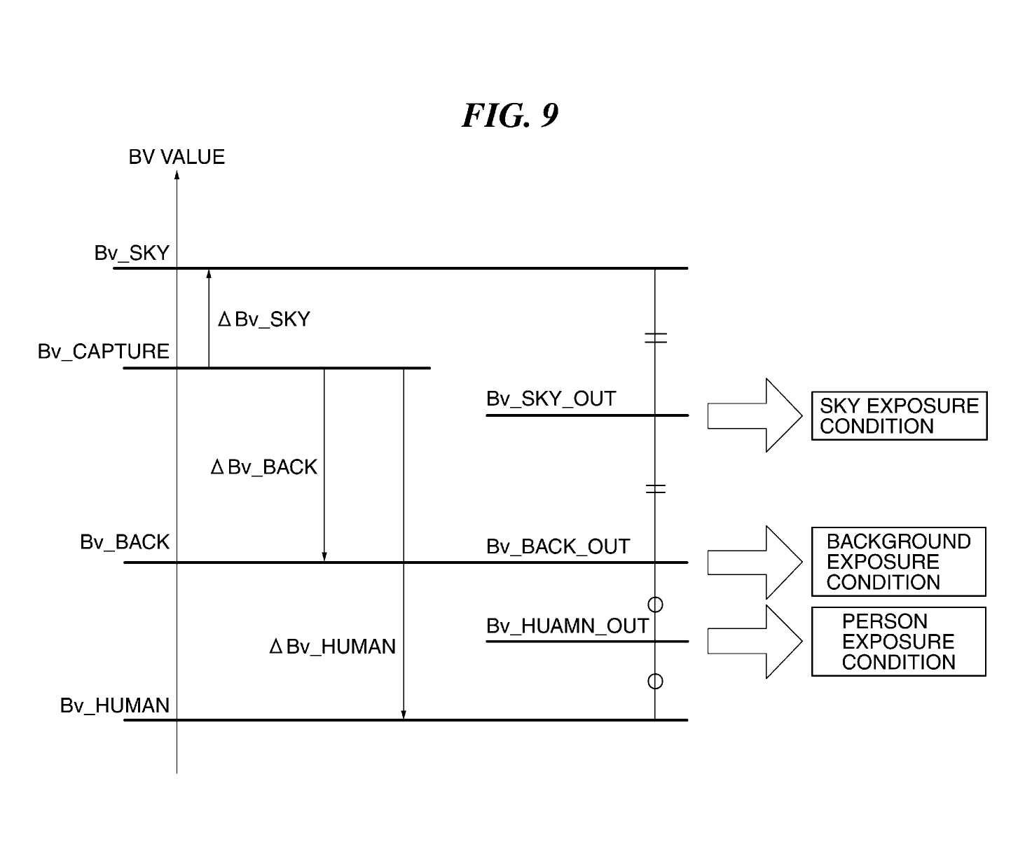

FIG. 8 shows in flowchart form the procedures of an exposure calculation process executed by the region-dependent exposure calculation unit 206 of the exposure decision unit 201 of the image processing apparatus 200. FIG. 9 shows an example of Bv value calculation in the exposure calculation process of FIG. 8.

At start of the exposure calculation process of FIG. 8, the region-dependent exposure calculation unit (also referred to as the exposure calculation unit) 206 calculates Bv value correction amounts for respective regions of the AE image based on the brightness values of the image regions calculated by the brightness calculation unit 204 in the brightness calculation process of FIG. 3 and target brightness values of the image regions (step S801).

A Bv value is a numerical value that represents brightness of image. In this example, the Bv value corresponds to the brightness value Y_SKY, Y_BACK, or Y_HUMAN of the sky, background, or person region of the AE image. The Bv value has a logarithmic characteristic relative to brightness. In other words, the brightness increases twofold with the increase of the Bv value by one.

The Bv value correction amount is an amount of correction to the Bv value (exposure control value), and is used for exposure condition control to control the brightness value of each image region to a target brightness value Y_TARGET_SKY, Y_TARGET_BACK, or Y_TARGET_HUMAN of the image region.

The Bv value correction amounts ΔBv_SKY, ΔBv_BACK, and ΔBv_HUMAN for sky, background, and person regions of the AE image can be calculated according to formulae (5)-(7) given below.

ΔBv_SKY=log₂(Y_SKY/Y_TARGET_SKY) (5)

ΔBv_BACK=log₂(Y_BACK/Y_TARGET_BACK) (6)

ΔBv_HUMAN=log₂(Y_HUMAN/Y_TARGET_HUMAN) (7)

As shown in FIG. 9, the Bv value correction amounts ΔBv_SKY and ΔBv_BACK are amounts of correction from a Bv value Bv_CAPTURE which is represented by the exposure condition for the AE image.

In step S802, the exposure calculation unit 206 calculates proper Bv values Bv_SKY, Bv_BACK, and Bv_HUMAN for respective image regions according to formulae (8)-(10) given below.

Bv_SKY=Bv_CAPTURE+ΔBv_SKY (8)

Bv_BACK=Bv_CAPTURE+ΔBv_BACK (9)

Bv_HUMAN=Bv_CAPTURE+ΔBv_HUMAN (10)

In step S803, the exposure calculation unit 206 decides, as a Bv value Bv_MAIN for the main object region, one of the proper Bv values for the respective regions calculated in step S802 (the proper Bv value Bv_BACK for the background region in this example), as shown in formula (11) given below.

Bv_MAIN=Bv_BACK (11)

The exposure calculation unit 206 also calculates output Bv values Bv_SKY_OUT, Bv_BACK_OUT, and Bv_HUMAN_OUT for the sky, background, and person regions based on the Bv value Bv_MAIN of the main object region and the proper Bv values Bv_SKY, Bv_BACK, and Bv_HUMAN for the respective image regions according to formulae (12)-(14) given below (step S803).

Bv_SKY_OUT=(Bv_SKY+Bv_MAIN)/2 (12)

Bv_BACK_OUT=(Bv_BACK+Bv_MAIN)/2 (13)

Bv_HUMAN_OUT=(Bv_HUMAN+Bv_MAIN)/2 (14)

As described above, the background region is selected as the main object region in this example. Formulae (12) and (14) indicate that the Bv values for the sky and person regions are controlled so as to be close to the Bv value Bv_MAIN for the main object region. In other words, appropriate exposures of the sky and person regions (which are different from proper exposures of these regions) are set by taking into account a relation between the brightness of the main object region and the brightnesses of other regions. This makes it possible to prevent a synthesized image from becoming an unnatural image (such as a synthesized image which is obtained by synthesizing images photographed with proper exposures for image regions into a single image) where brightness discontinuity is caused between image regions.

Next, the exposure calculation unit 206 decides exposure conditions for respective image regions based on the output Bv values for the image regions (step S804). It is assumed in this example that the exposure conditions decided in step S804 are each determined by aperture value, shutter speed, and photographing sensitivity and that the exposure conditions are each controlled based only on shutter speed and photographing sensitivity according to the output Bv value by an exposure condition control method set beforehand in the image pickup apparatus. With this exposure condition control, it is possible to prevent the synthesized image from being degraded in quality due to a phenomenon (such as extent of blur or image magnification being changed between photographed images) that occurs in a case that plural images are photographed while changing the aperture value.

As described above, according to the exposure calculation process of FIG. 8, exposure conditions appropriate to respective image regions are calculated by and output from the exposure calculation unit 206 of the exposure decision unit 201.

The region-dependent exposure image pickup unit (also referred to as the exposure image pickup unit) 207 of the image processing apparatus 200 performs a photographing operation in exposure conditions decided by the exposure calculation unit 206. In this embodiment, three images (hereinafter, referred to as the sky exposure image, background exposure image, and person exposure image, respectively, and collectively referred to as the region-dependent exposure images) are photographed with exposures respectively appropriate to sky, background, and person.

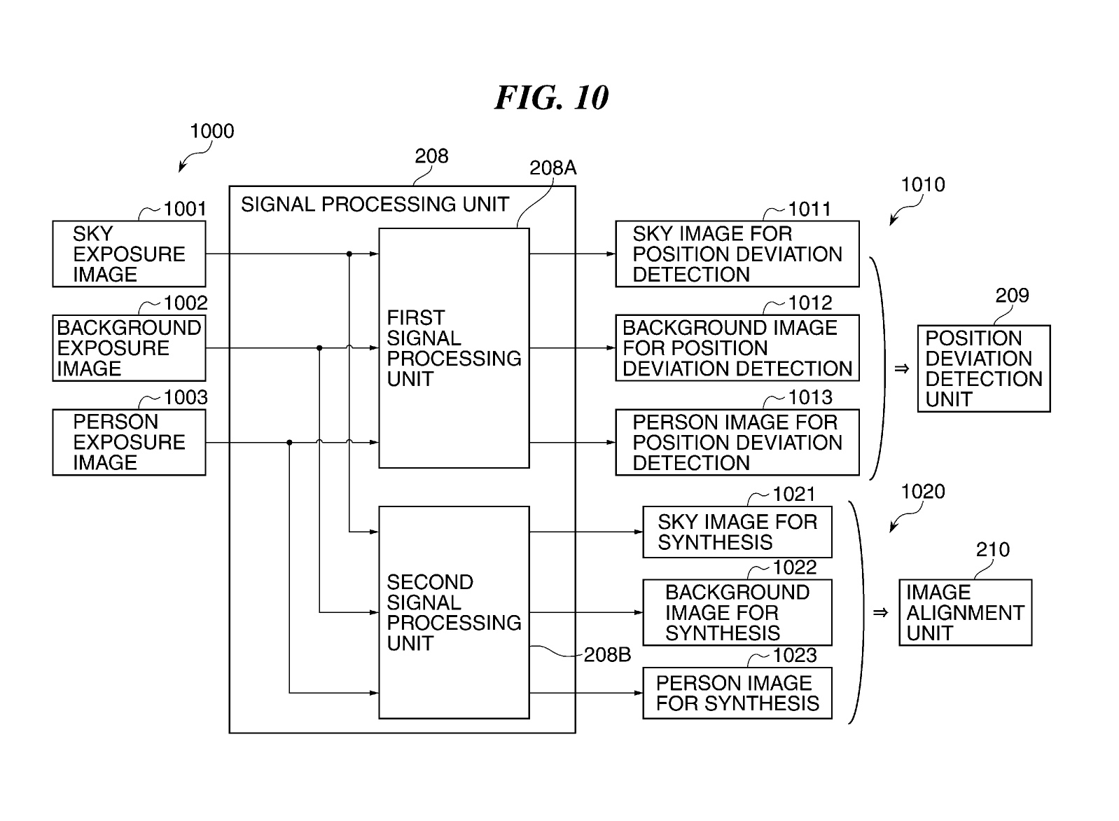

FIG. 10 shows an operation of the signal processing unit 208 of the image processing apparatus 200.

The signal processing unit 208 has a first signal processing unit 208A that performs first signal processing to generate images 1010 for position deviation detection from the region-dependent exposure images 1000 supplied from the exposure image pickup unit 207, and has a second signal processing unit 208B that performs second signal processing to generate images 1020 for synthesis from the region-dependent exposure images 1000.

In the first signal processing, the images 1010 for position deviation detection are generated from the region-dependent exposure images 1000. More specifically, a sky image 1011 for position deviation detection, a background image 1012 for position deviation detection, and a person image 1013 for position deviation detection are respectively generated from the sky exposure image 1001, background exposure image 1002, and person exposure image 1003. These images 1010 for position deviation detection are output to the position deviation detection unit 209 of the image processing apparatus 200.

The region-dependent exposure images 1000 supplied from the exposure image pickup unit 207 to the signal processing unit 208 are different in brightness level from one another. On the other hand, it is preferable that the images 1010 for position deviation detection be uniform in brightness level. To this end, in the first signal processing, a gain adjustment is made to adjust the brightness levels of the region-dependent exposure images 1000 to make the images 1010 for position deviation detection uniform in brightness level. It should be noted that it is not limited to whichever brightness level among the brightness levels of the exposure images 1011-1013 with which the brightness levels of other images are to be matched. In the first signal processing, brightness gradation conversion, noise reduction, etc. are also performed.

In the second signal processing, the images 1020 for synthesis are generated from the region-dependent exposure images 1000. More specifically, the sky image 1021 for synthesis, background image 1022 for synthesis, and person image 1023 for synthesis are generated from the sky exposure image 1001, background exposure image 1002, and person exposure image 1003, respectively. In the second signal processing, although brightness gradation conversion, noise reduction, etc. are performed, a gain adjustment to make the region-dependent exposure images 1000 uniform in brightness level is not performed unlike in the first signal processing. The images 1020 for synthesis are output to the image alignment unit 210 of the image processing apparatus 200.

Due to hand shake, a position deviation is caused among the region-dependent exposure images 1000 photographed by the exposure image pickup unit 207. It is therefore necessary to detect and correct the position deviation among these images prior to being synthesized.

The position deviation detection unit 209 of the image processing apparatus 200 inputs the images 1010 for position deviation detection from the signal processing unit 208, and detects position deviations among the images. In this embodiment, the position deviation detection unit 209 detects position deviations by using an existing technique such as where an image is divided into blocks from which a group of movement vectors relative to a reference image is calculated, and coefficients in projective transformation representing position deviations are calculated by least square method using information of the calculated group of movement vectors.

In this embodiment, the background image 1012 for position deviation detection is obtained by performing the first signal processing on the background exposure image 1002 photographed by the exposure image pickup unit 207 with the exposure for the background region (main object region), and this background image 1012 for position deviation detection is used as the reference image. Then, position deviation parameters H1, H2 (projective transformation coefficients) that represent position deviations of the sky and person images 1011, 1013 for position deviation detection relative to the reference image (i.e., the background image 1012 for position deviation detection) are calculated by and output from the position deviation detection unit 209.

The image alignment unit 210 of the image processing apparatus 200 aligns positions of the images 1020 for synthesis generated in the second signal processing. In this example, the image alignment unit 210 modifies the sky and person images 1021, 1023 for synthesis by using the position deviation parameters H1, H2 that are output from the position deviation detection unit 209, thereby obtaining sky and person images for synthesis that are aligned in position with the background image 1022 for synthesis.

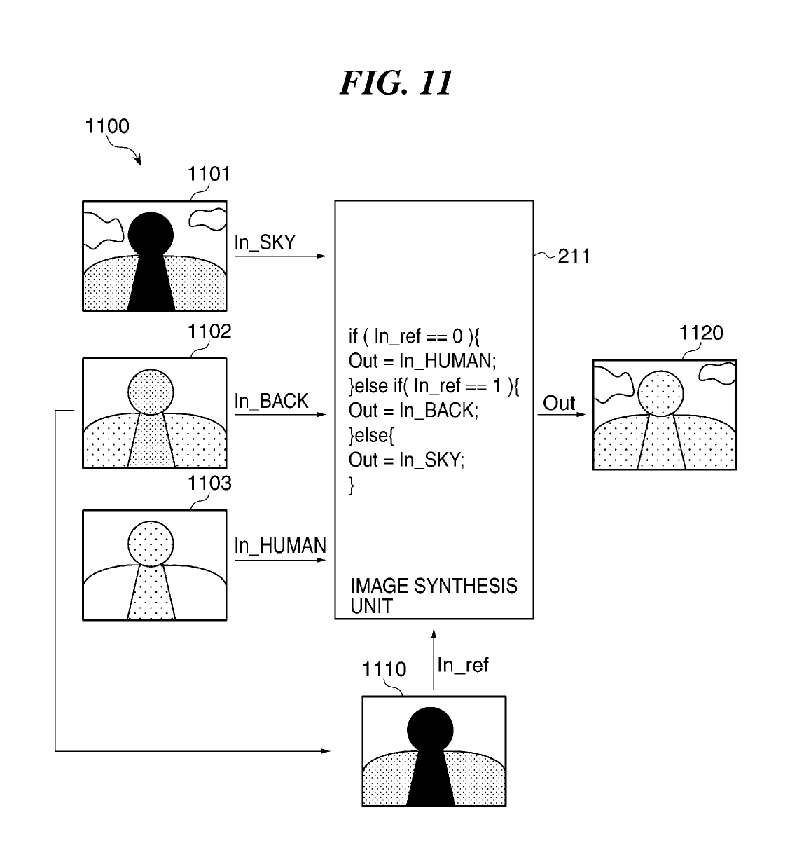

FIG. 11 shows an operation of the image synthesis unit 211 of the image processing apparatus 200. The image synthesis unit 211 synthesizes three images for synthesis 1100, which are aligned in position with one another by the image alignment unit 210, into a single synthesized image 1120. The image synthesis unit 211 is input with the three images for synthesis 1100 aligned with one another and is also input with a ternary image 1110. The ternary image 1110 is generated from the alignment reference image (the background image 1022 for synthesis in this example), and at that time, the ternary image 1110 is divided into sky, background, and person regions by an arbitrary region division method, and different values are allocated to these regions of the ternary image 1110. For example, a value of 2 is allocated to the sky region, a value of 1 is allocated to the background region, and a value of 0 is allocated to the person region.

As shown in FIG. 11, the image synthesis unit 211 inputs a sky image for synthesis 1101, background image for synthesis 1102, and person image for synthesis 1103 according to the values allocated to the sky, background, and person regions of the ternary image 1110, and generates the synthesized image 1120. In other words, the sky image for synthesis 1101, background image for synthesis 1102, and person image for synthesis 1103 are respectively used for generation of sky, background, and person regions of the synthesized image 1120.

The synthesized image 1120 whose sky, background, and person regions have appropriate exposures is generated by the image synthesis unit 211 as described above, and is output to the image display unit 212 and to the image storage unit 213 of the image processing apparatus 200. The image display unit 212 displays the synthesized image 1120, and the image storage unit 213 stores image data of the synthesized image 1120.

As described above, according to this embodiment, an image is divided into predetermined image regions, appropriate exposure conditions for these image regions are determined based on a relation between brightnesses of the image regions, and plural images respectively photographed in the determined exposure conditions are synthesized into a synthesized image. It is therefore possible to obtain an image closer to what is seen with eyes and broader in dynamic range, as compared to an image obtained by a conventional method that compresses the gradation of the whole image with a predetermined brightness gradation conversion characteristic.

### Second Embodiment

In the following, a description will be given of an image processing apparatus according to a second embodiment.

In the second embodiment, a desired image is generated from a single image by multiplying image regions, which are different in appropriate exposure conditions from one another, with different gains, unlike the first embodiment where plural images respectively photographed in exposure conditions appropriate for image regions are synthesized into a synthesized image.

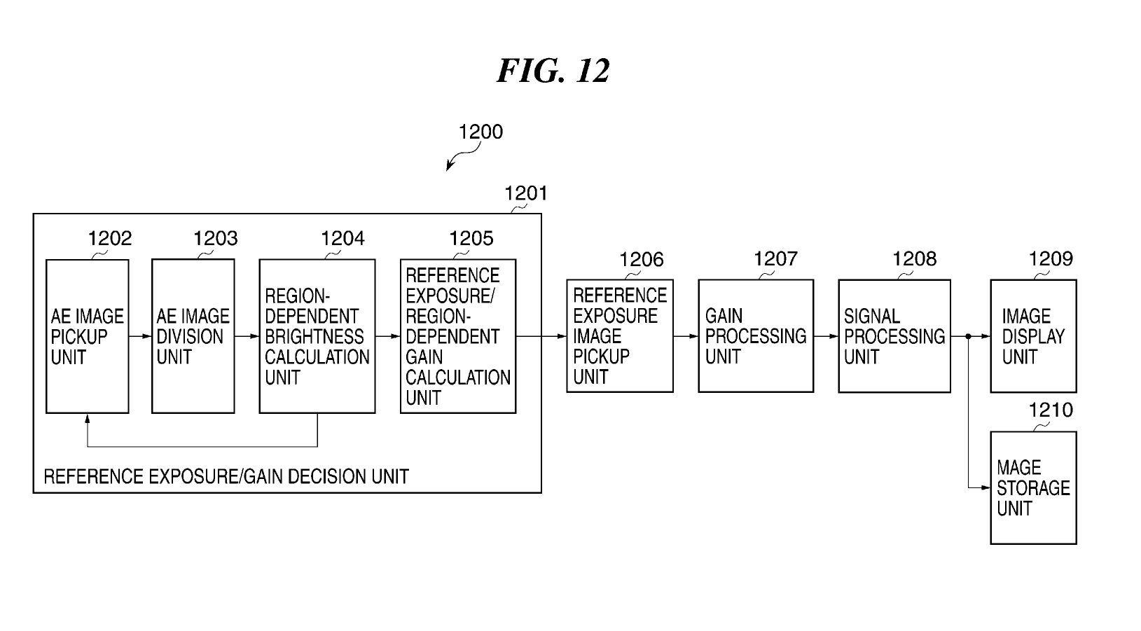

FIG. 12 shows in block diagram form the construction of the image processing apparatus of the second embodiment. This image processing apparatus 1200 has a reference exposure/gain decision unit 1201, reference exposure image pickup unit 1206, gain processing unit 1207, signal processing unit 1208, image display unit 1209, and image storage unit 1210.

The reference exposure/gain decision unit 1201 has an AE image pickup unit 1202, AE image division unit 1203, region-dependent brightness calculation unit 1204, and reference exposure/region-dependent gain calculation unit 1205.

The AE image pickup unit 1202, AE image division unit 1203, and region-dependent brightness calculation unit 1204 respectively perform AE image pickup/acquisition processing, AE image division processing, and brightness calculation process that are the same as those executed by the AE image pickup unit 202, AE image division unit 203, and region-dependent brightness calculation unit 204 of the first embodiment, and a description of which will be omitted.

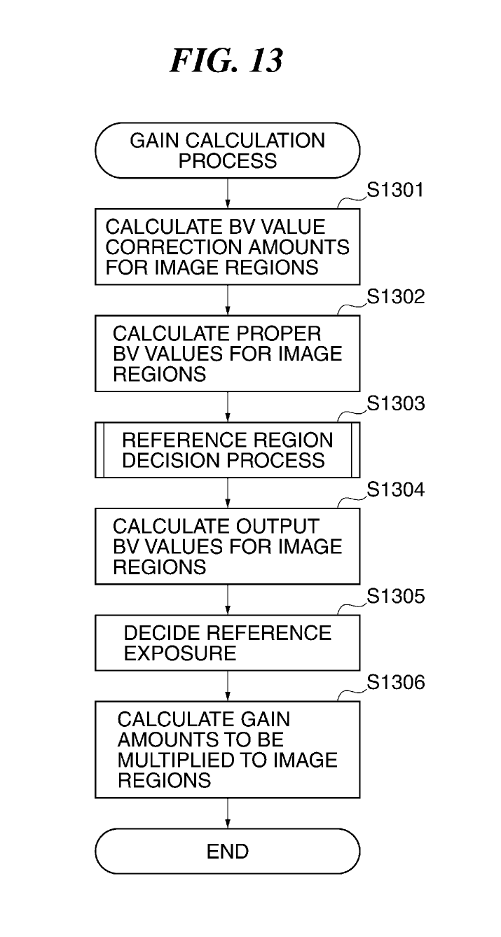

FIG. 13 shows in flowchart form the procedures of a gain calculation process executed by the reference exposure/region-dependent gain calculation unit (hereinafter, referred to as the exposure/gain calculation unit) 1205 of the reference exposure/gain decision unit 1201 of the image processing apparatus 1200.

At start of the gain calculation process of FIG. 13, the exposure/gain calculation unit 1205 calculates, as in step S801 in FIG. 8, Bv value correction amounts based on brightness values of and target brightness values for respective regions of an AE image (step S1301), and calculates, as in step S802 in FIG. 8, proper Bv values for these regions of the AE image by using the Bv value correction amounts (step S1302).

Next, the exposure/gain calculation unit 1205 executes a reference region decision process (step S1303), thereby deciding a reference region, i.e., a region that is to be used as a reference to decide an exposure condition in which a single image is to be photographed.

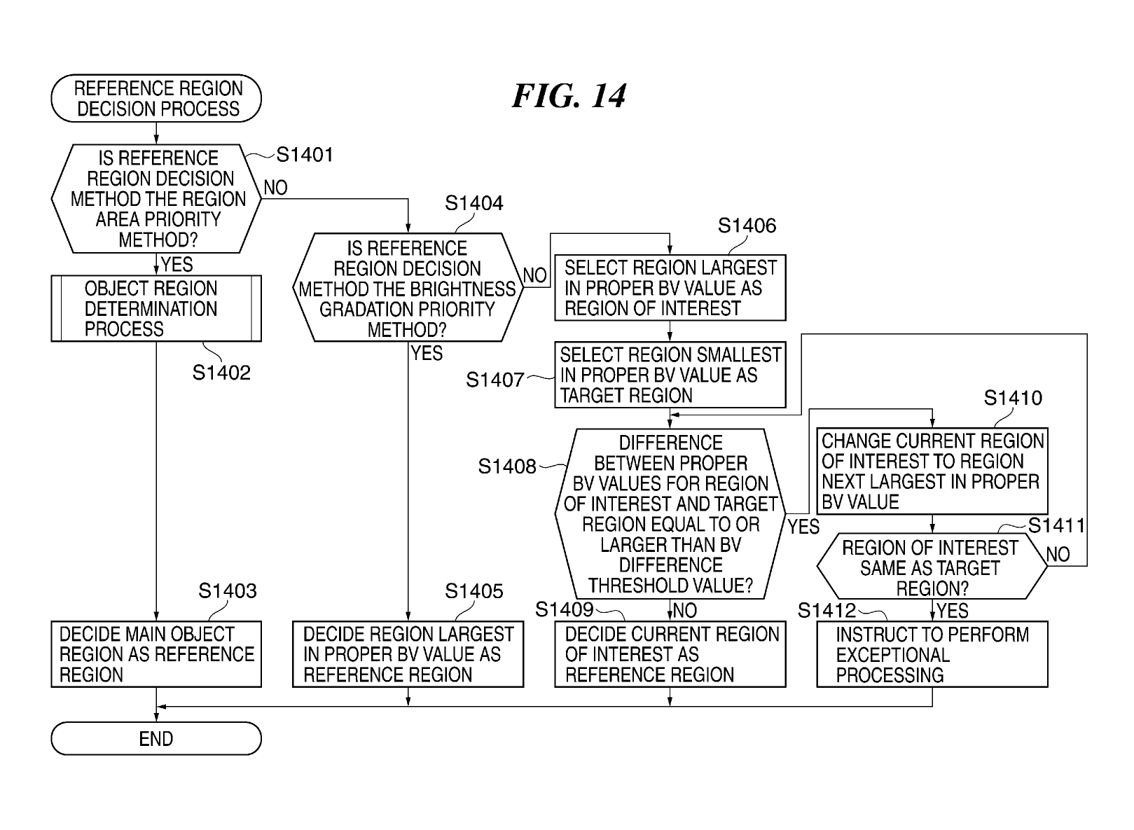

FIG. 14 shows in flowchart form the procedures of the reference region decision process executed in step S1303 by the exposure/gain calculation unit 1205.

In this embodiment, a region area priority method, a brightness gradation priority method, or a low-noise priority method is used to decide the reference region. The desired method can be selected from these methods and can be set in advance in the image processing apparatus. Alternatively, the desired method can be switched according to a photographing scene, or can be selected by the user.

At start of the reference region decision process of FIG. 14, the exposure/gain calculation unit 1205 determines whether the reference region decision method is the region area priority method (step S1401).

The region area priority method refers to a method where a main object region is determined and decided as a reference region, as in the object region determination process executed by the main object region decision unit 205 in the first embodiment.

If the reference region decision method is the region area priority method (YES to step S1401), the exposure/gain calculation unit 1205 performs an object region determination process that is the same as that performed by the main object region decision unit 205 (step S1402). More specifically, the exposure/gain calculation unit 1205 calculates evaluation values VAL by multiplying areas (sizes) S of respective regions of the AE image by the predetermined coefficient k, and determines as the main object region the region which is the largest in evaluation value. Next, in step S1403, the exposure/gain calculation unit 1205 decides as the reference region the main object region determined in step S1402, and completes the present process and returns to the gain calculation process of FIG. 13.

If the reference region decision method is not the region area priority method (NO to step S1401), the exposure/gain calculation unit 1205 determines whether the reference region decision method is the brightness gradation priority method (step S1404).

If the reference region decision method is the brightness gradation priority method (YES to step S1404), the exposure/gain calculation unit 1205 decides the region which is the largest in proper Bv value as the reference region (step S1405). In the brightness gradation priority method, the region which is the largest in proper Bv value is decided as the reference region in this manner.

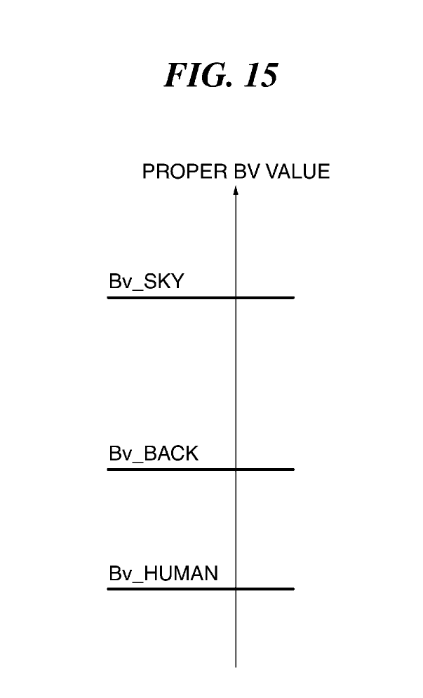

FIG. 15 shows an example of proper Bv values for respective regions of an AE image to which the brightness gradation priority method is applied. In the example of FIG. 15, the proper Bv value for the sky region is the largest among the proper Bv values Bv_SKY, Bv_BACK, and Bv_HUMAN for the sky, background, and person regions of the AE image, and therefore the sky region becomes the reference region in the brightness gradation priority method. In this case, the background and person regions are often photographed with exposures which are on the underexposure side as compared to appropriate brightnesses to prevent an occurrence of a white spot in the sky region. The brightness gradation priority method is advantageous in that brightnesses of regions other than the reference region (e.g., brightnesses of the background and person regions) can be controlled to have desired levels by multiplying appropriate gains to the brightnesses of these regions, whereby the brightness gradation of the whole image can be maintained satisfactorily.

If the reference region decision method is not the brightness gradation priority method (NO to step S1404), the exposure/gain calculation unit 1205 determines that the reference region decision method is the low-noise priority method.

The low-noise priority method refers to a method in which the reference region is set to prevent gain amounts to be multiplied to an image from exceeding a gain amount upper limit, which is set based on a relation among the resolution and noise level of the image pickup element and an allowable noise amount in the image. The gain amounts are calculated based on Bv differences among image regions. An allowable amount of Bv differences (hereinafter, referred to as the Bv difference threshold value) can be calculated, if the upper limit of the gain amounts is set.

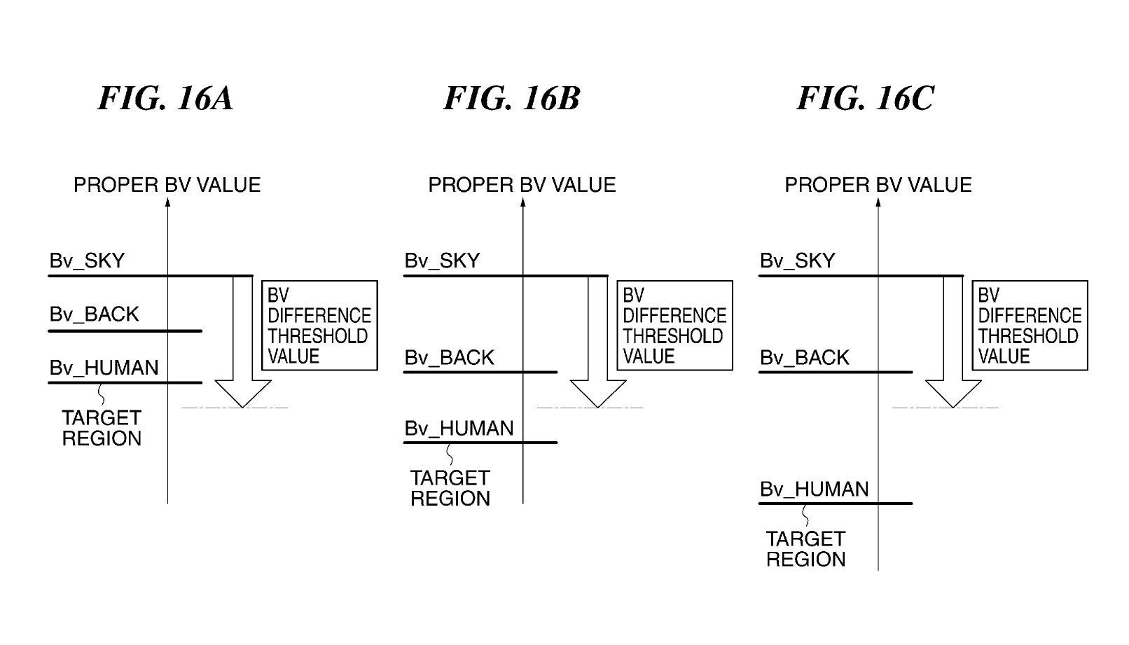

FIGS. 16A-16C show examples of proper Bv values and a Bv difference threshold value for respective regions of an AE image to which the low-noise priority method is applied.

In the case of deciding the reference region by the low-noise priority method, the exposure/gain calculation unit 1205 selects, as the region of interest, a region that is the largest in proper Bv value (the sky region in the example of FIGS. 16A-16C) (step S1406), and selects, as the target region, a region that is the smallest in proper Bv value (the person region in the example of FIGS. 16A-16C) (step S1407).

Next, the exposure/gain calculation unit 1205 determines a difference between the proper Bv values for the region of interest and the target region (this difference corresponds to a maximum value of gain amounts to be applied to an image photographed such that the region of interest is appropriately photographed), and determines whether the determined difference is equal to or larger than the Bv difference threshold value (step S1408).

If the difference between the proper Bv values for the region of interest and the target region is smaller than the Bv difference threshold value as shown in FIG. 16A (NO to step S1408), the exposure/gain calculation unit 1205 determines that the maximum value of gain amounts is smaller than the upper limit of the gain amounts, and selects and decides the current region of interest (the sky region in the example of FIG. 16A) as the reference region (step S1409).

On the other hand, if the difference between the proper Bv values is equal to or larger than the Bv difference threshold value (YES to step S1408), the exposure/gain calculation unit 1205 determines that the maximum value of gain amounts is larger than the upper limit of the gain amounts, and changes the current region of interest to the region that is the next largest in proper Bv value (the background region in the example of FIG. 16B) (step S1410).

Next, the exposure/gain calculation unit 1205 determines whether the region of interest is the same as the target region (step S1411). If the region of interest is not the same as the target region (NO to step S1411), the flow returns to step S1408 where a difference between the proper Bv value for the region of interest after change and the proper Bv value for the target region is determined and whether this difference is equal to or larger than the Bv difference threshold value is determined.

In the example of FIG. 16B, a Bv difference between the sky and person regions is equal to or larger than the Bv difference threshold value, but a difference between the proper Bv value Bv_BACK for the background region and the proper Bv value Bv_HUMAN for the person region (target region) is smaller than the Bv difference threshold value. Thus, the answer to step S1408 becomes NO, and the background region is selected and decided as the reference region in step S1409.

On the other hand, if the region of interest is the same as the target region (YES to step S1411), i.e., if the Bv difference between the target region and any other region is equal to or larger than the Bv difference threshold value, the exposure/gain calculation unit 1205 instructs to perform exceptional processing, e.g., strobe emission processing (step S1412). In the example of FIG. 16C, the instruction for execution of exceptional processing is given since the Bv difference between the sky and person regions and the Bv difference between the background and person regions are each equal to or larger than the Bv difference threshold value.

It should be noted that if the background region is selected as the reference region in the example of FIG. 16B, the sky region becomes overexposure in an image photographed such that the background region is appropriately photographed. Accordingly, to control the sky region to have an appropriate brightness, the gain amount to be applied to the sky region must be decreased. In that case, however, color balance is lost at apart where the brightness saturates, and an unexpected color is generated in the image. On the other hand, if the gain amount to be applied to the sky region is not decreased, the overexposed sky region is output as it is, and the gradation (tone) characteristic is lost as compared to the case where the sky region is selected as the reference region in the brightness gradation priority method.

After the reference region is decided as described above, the exposure/gain calculation unit 1205 completes the reference region decision process of FIG. 14 and returns to the gain calculation process of FIG. 13, and then calculates output Bv values for respective regions (step S1304). In this embodiment, the proper Bv value for the reference region is used as the Bv value Bv_MAIN for the main object region in formula (11), and output Bv values Bv_SKY_OUT, Bv_BACK_OUT, and Bv_HUMAN_OUT for the respective image regions are calculated according to formulae (12)-(14) given above.

Next, the exposure/gain calculation unit 1205 selects, as the reference Bv value, the output Bv value for the reference region from among the output Bv values calculated in step S1304, and decides as the reference exposure an exposure condition corresponding to the reference Bv value (step S1305). The exposure/gain calculation unit 1205 then calculates differences between the reference Bv value and the Bv values for respective image regions, and calculates gain amounts to be multiplied to the image regions (step S1306).

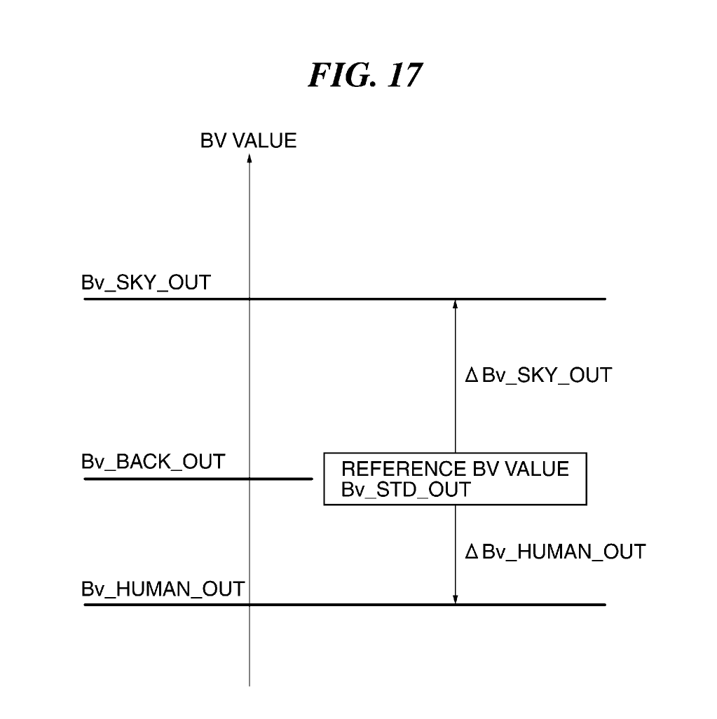

FIG. 17 shows an example of Bv values for respective image regions, the reference Bv value, and differences between the reference Bv value and the Bv values for the image regions when the background region is selected as the reference region.

In the example of FIG. 17, the exposure/gain calculation unit 1205 sets the output Bv value Bv_BACK_OUT for the background region (reference region) as the reference Bv value Bv_STD_OUT according to formula (15) given below, whereby the exposure condition corresponding to the output Bv value for the background region is decided as the reference exposure in step S1305. Next, the exposure/gain calculation unit 1205 calculates, in step S1306, differences ΔBv_SKY_OUT, ΔBv_BACK_OUT, and ΔBv_HUMAN_OUT between the reference Bv value and the Bv values for respective regions according to formulae (15)-(17) given below, and calculates gain amounts GAIN_SKY, GAIN_BACK, and GAIN_HUMAN to be multiplied to respective regions according to formulae (19)-(21) given below.

Bv_STD_OUT=Bv_BACK_OUT (15)

ΔBv_SKY_OUT=Bv_STD_OUT−Bv_SKY_OUT (16)

ΔBv_BACK_OUT=Bv_STD_OUT−Bv_BACK_OUT (17)

ΔBv_HUMAN_OUT=Bv_STD_OUT−Bv_HUMAN_OUT (18)

GAIN_SKY=2̂ΔBv_SKY_OUT (19)

GAIN_BACK=2̂ΔBv_BACK_OUT (20)

GAIN_HUMAN=2̂ΔBv_HUMAN_OUT (21)

In the example of FIG. 17, relations of ΔBv_SKY_OUT<0, ΔBv_BACK_OUT=0, and ΔBv_HUMAN_OUT>0 are fulfilled, and therefore relations of GAIN_SKY<1, GAIN_BACK=1, and GAIN_HUMAN>1 are fulfilled.

When photographing is made with exposure that makes the output Bv value for the background region proper, the sky region which is larger in Bv value than the background region (i.e., brighter than the background region) is photographed in more overexposure than in an appropriate exposure condition, and the person region smaller in Bv value (i.e., darker) than the background region is photographed in more underexposure than in an appropriate exposure condition. In that case, to appropriately control the brightnesses of the sky and person regions, a gain amount less than 1 is multiplied to the sky region, a gain amount equal to or larger than 1 is multiplied to the person region, and a gain amount equal to 1 is multiplied to the background region. To prevent color balance from being lost due to the gain amount less than 1 being multiplied, the gain amount less than 1 (e.g., the gain amount GAIN_SKY for the sky region in the example of FIG. 17) is increased to 1.

As described above, according to the gain calculation process of FIG. 13, the reference exposure and the gain amounts to be multiplied to respective image regions are decided by and output from the exposure/gain calculation unit 1205 of the reference exposure/gain decision unit 1201. The reference exposure image pickup unit 1206 of the image processing apparatus 1200 photographs a single reference exposure image with the reference exposure output from the reference exposure/gain decision unit 1201.

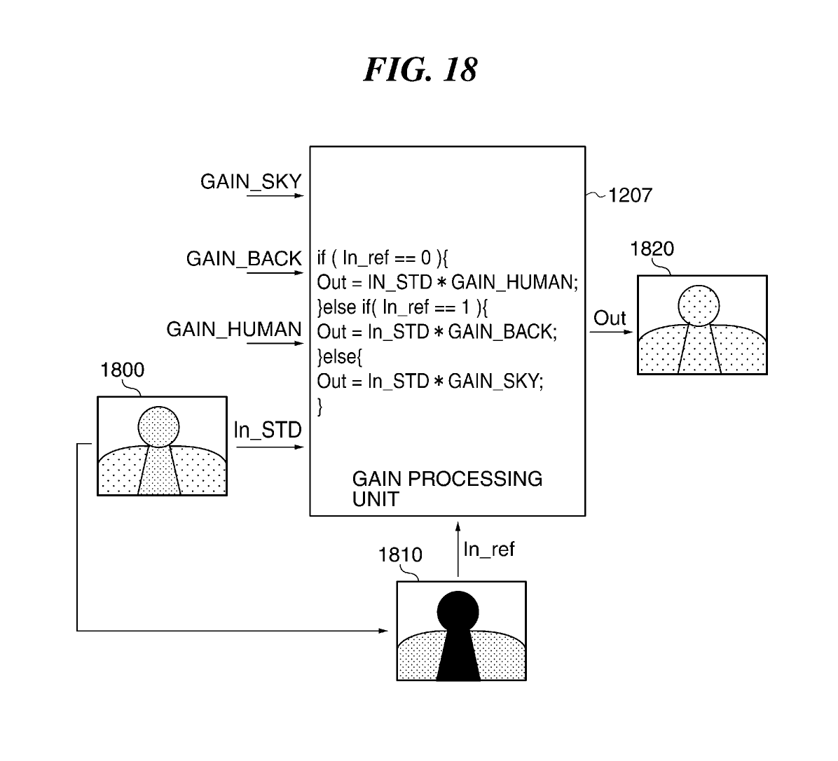

FIG. 18 schematically shows operation of the gain processing unit 1207 of the image processing apparatus 1200.

The gain processing unit 1207 is input with gain amounts GAIN_SKY, GAIN_BACK, and GAIN_HUMAN that are calculated by the exposure/gain calculation unit 1205 and that are to be multiplied to the sky, background, and person regions, is input with a reference exposure image (e.g., background exposure image) 1800 photographed by the reference exposure image pickup unit 1206, and is input with a ternary image 1810. As with the ternary image 1110 of FIG. 11 in the first embodiment, values of 0, 1, and 2 are respectively allocated to the person, background, and sky regions of the ternary image 1810.

The gain processing unit 1207 multiplies the gain amounts GAIN_SKY, GAIN_BACK, and GAIN_HUMAN respectively to the sky, background, and person regions of the reference exposure image, while changing the gain amounts according to the values allocated to respective regions of the ternary image 1810, thereby generating a gain image 1820.

As described above, the gain image 1820 having regions to which appropriate gain amounts are respectively multiplied is generated by and output from the gain processing unit 1207.

The signal processing unit 1208 of the image processing apparatus 1200 performs signal processing such as predetermined brightness gradation conversion and noise reduction on the gain image 1820 output from the gain processing unit 1207. The image processed in the signal processing unit 1208 is supplied as a final image (output image) to the image display unit 1209 and to the image storage unit 1210. The image display unit 1209 displays the output image, and the image storage unit 213 stores image data of the output image.

As described above, according to this embodiment, an image is divided into predetermined image regions, a reference exposure condition is determined based on a relation among brightnesses of respective image regions, and gain amounts appropriate for the image regions are multiplied to an image photographed in the reference exposure condition to thereby obtain a final output image. It is therefore possible to obtain an image that is closer to what is seen with eyes and broader in dynamic range as compared to an image obtained by a conventional method that compresses the gradation of the whole image with a predetermined brightness gradation conversion characteristic.

### Third Embodiment

In the following, a description will be given of an image processing apparatus according to a third embodiment.

In the first embodiment, processing is performed to synthesize plural images photographed with different exposures into a synthesized image (hereinafter, referred to as the plural images-based processing). The plural images-based processing is advantageous in that a noise amount in the synthesized image can be made small and can be made uniform between region images by controlling exposures by changing the shutter speed while not changing the photographing sensitivity. However, if a person to be photographed is moving, a problem is posed that a region in which a part of a person image appears (hereinafter, referred to as the occlusion region) is generated in a background or sky region of the synthesized image obtained by the plural images-based processing.

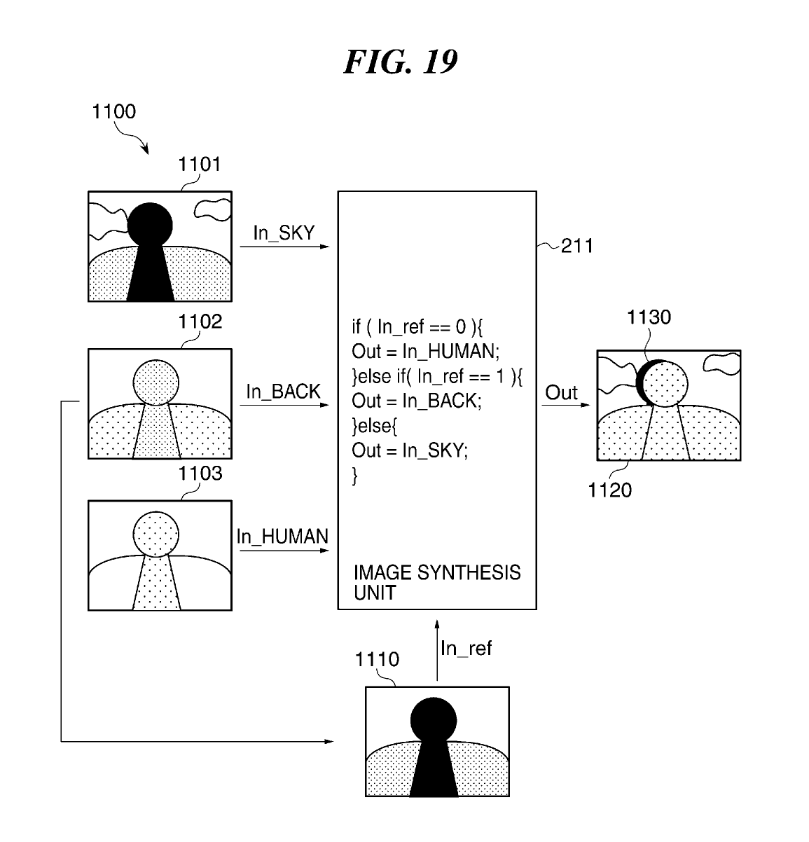

FIG. 19 schematically shows an occlusion region generated in a synthesized image. When the image synthesis unit 211 inputs a sky image for synthesis 1101, background image for synthesis 1102, and person image for synthesis 1103 according to values allocated to respective regions of a ternary image 1110 and synthesizes these images into a synthesized image 1120 as in the case of FIG. 11, an occlusion region 1130 is sometimes generated in the synthesized image 1120 as shown in FIG. 19, if a photographed person is moving.

In the second embodiment, processing (hereinafter, referred to as the single image-based processing) is performed in which gain amounts different between image regions are multiplied to a single photographed image to obtain a desired image. The single image-based processing is advantageous in that no occlusion region is generated in the photographed image. However, the single image-based processing that multiplies gain amounts different between image regions poses a problem that an amount of noise generation differs between the image regions, and poses a problem that the amount of noise generation becomes large in an image region multiplied with a large gain amount, resulting in degraded image quality.

In the third embodiment, in order to improve the image quality, the plural images-based processing or the single image-based processing is selectively carried out according to object state, e.g., according to differences among brightnesses of image regions that correspond to amounts of noise generation or according to an amount of a person's movement that corresponds to degree of generation of occlusion region.

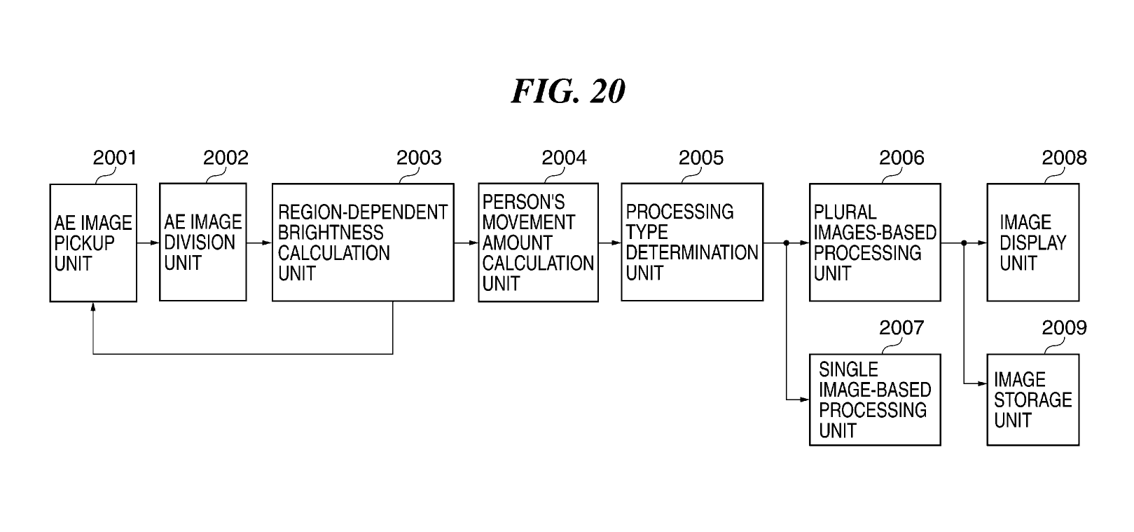

FIG. 20 shows in block diagram form an image processing apparatus of the third embodiment.

This image processing apparatus 2000 has an AE image pickup unit 2001, AE image division unit 2002, region-dependent brightness calculation unit 2003, person's movement amount calculation unit 2004, processing type determination unit 2005, plural images-based processing unit 2006, single image-based processing unit 2007, image display unit 2008, and image storage unit 2009.

The AE image pickup unit 2001, AE image division unit 2002, and region-dependent brightness calculation unit 2003 perform AE image pickup/acquisition processing, AE image division processing, and brightness calculation process which are the same as processing performed by the AE image pickup unit 202, AE image division unit 203, and region-dependent brightness calculation unit 204 of the exposure decision unit 201 of the first embodiment, and a description of which will be omitted.

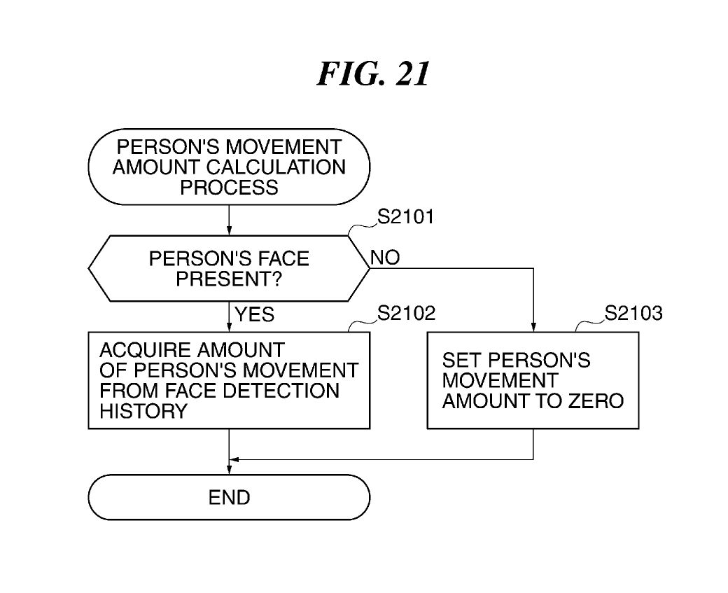

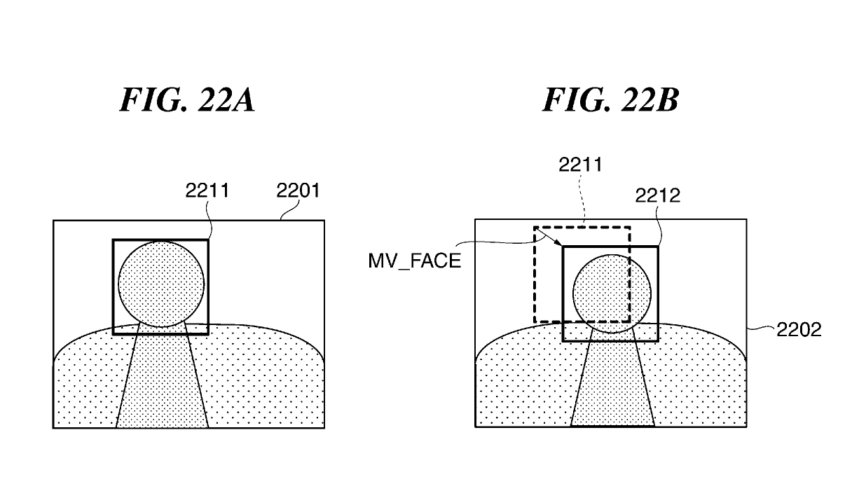

FIG. 21 shows in flowchart form the procedures of a person's movement amount calculation process executed by the person's movement amount calculation unit 2004 of the image processing apparatus 2000. FIGS. 22A and 22B schematically show the person's movement amount calculation process executed by the person's movement amount calculation unit (hereinafter, referred to as the movement amount calculation unit) 2004.

At start of the person's movement amount calculation process of FIG. 21, the movement amount calculation unit 2004 determines whether face detections in an AE image and an preceding image have succeeded, thereby determining whether a person's face is present in each of these images (step S2101).

The AE image is photographed one time or plural times. If, for example, that a new exposure value is output in step S313 or S314 in the brightness calculation process of FIG. 3, the AE image is again photographed based on the new exposure value. In a case that the AE image is photographed plural times, the term “preceding image” refers to the AE image photographed at a timing immediately before the AE image is finally determined. If the AE image is photographed only one time, the term “preceding image” refers to an image photographed for display on an electronic view finder at a timing immediately before the AE image is photographed.

In FIG. 22A, reference numeral 2201 denotes the preceding image, and reference numeral 2211 denotes a person's face detected from the preceding image 2201. In FIG. 22B, reference numeral 2202 denotes the AE image, and reference numerals 2211, 2212 respectively denote persons' faces detected from the preceding image 2201 and the AE image 2202.

If a person's face is present in each of the AE image and the preceding image (YES to step S2101), the movement amount calculation unit 2004 acquires an amount of a person's movement from a face detection history (step S2102). In this embodiment, when the persons' faces 2211, 2212 are detected from the preceding image 2201 and the AE image 2202, at least start coordinates of the face regions 2211, 2212 are output. The movement amount calculation unit 2004 calculates a magnitude of a vector MV_FACE that represents a difference between the start coordinate of the face region 2211 in the preceding image 2201 and the start coordinate of the face region 2212 in the AE image 2202, and acquires the magnitude of the vector MV_FACE as an amount of a person's movement.

On the other hand, no person's face is present in each of the AE image and the preceding image (NO to S2101), the movement amount calculation unit 2004 sets the amount of person's movement to zero (step S2103).

It should be noted that if plural persons' faces are detected from each of the AE image and the preceding image, the face of one person who is the main object is determined, and the amount of person's movement is calculated based on a determination result.

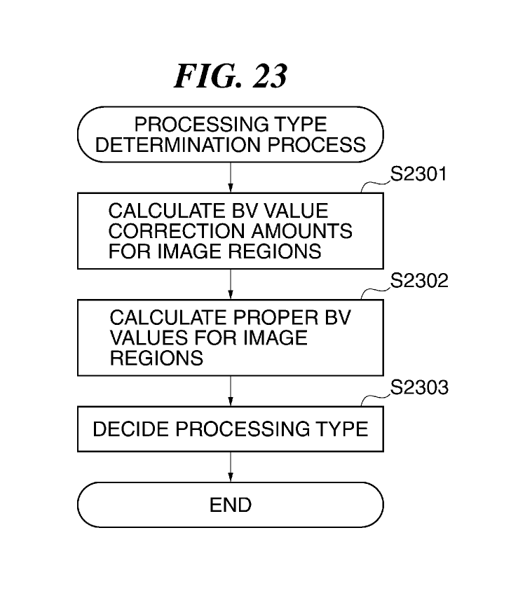

FIG. 23 shows in flowchart form the procedures of a processing type determination process executed by the processing type determination unit 2005.

At start of the processing type determination process, the processing type determination unit 2005 calculates Bv value correction amounts for respective image regions based on brightness values and target brightness values for the respective regions of the AE image, as in step S801 of the exposure calculation process of FIG. 8 (step S2301), and calculates proper Bv values for the respective regions of the AE image based on the Bv value correction amounts, as in step S802 of FIG. 8 (step S2302).

Next, the processing type determination unit 2005 performs a processing type decision to decide either the plural images-based processing or the single image-based processing, whichever is to be used (step S2303), and completes the present process.

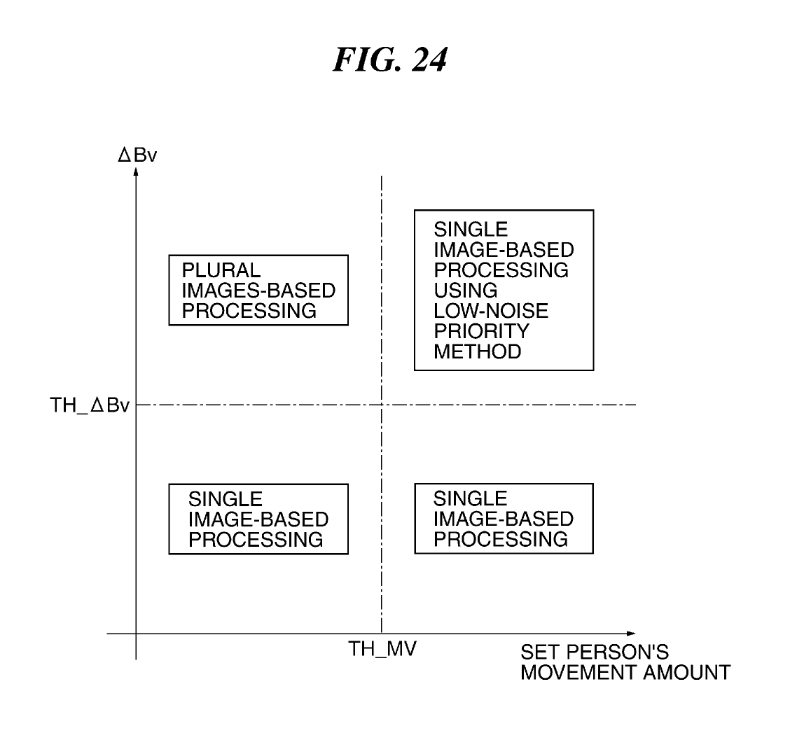

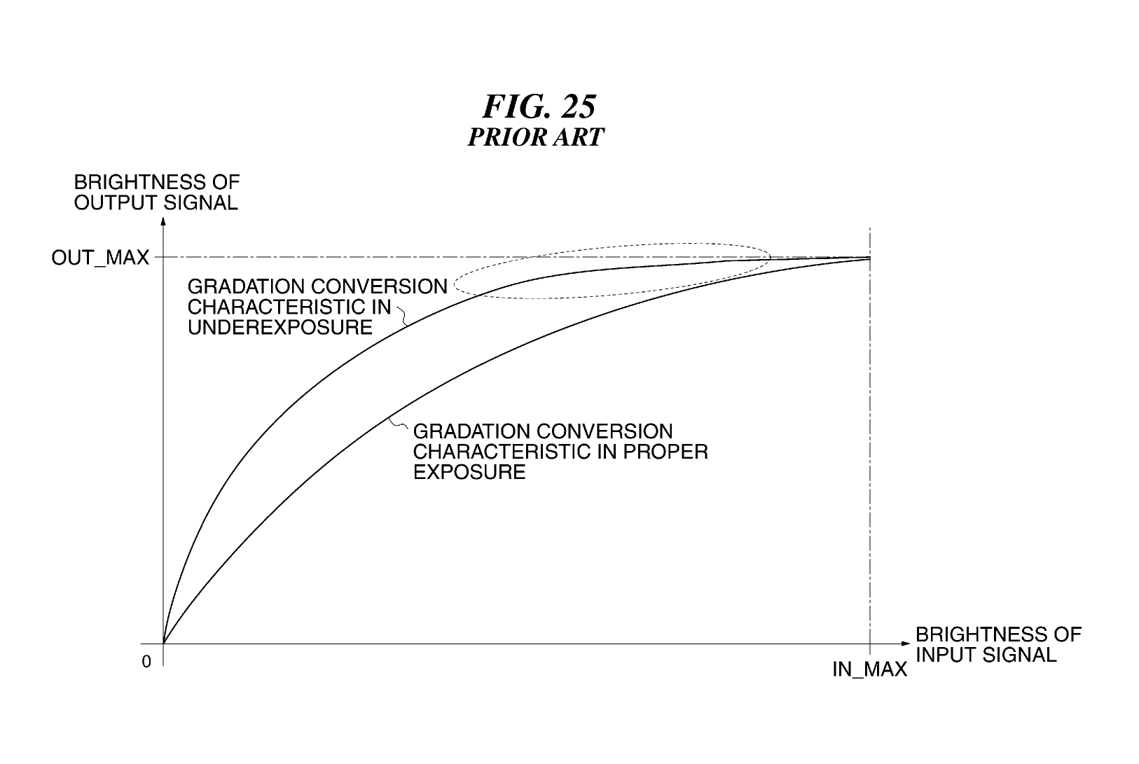

FIG. 24 shows the processing type decision method. For the processing type decision, an amount of a person's movement and a difference ΔBv between maximum and minimum values of a proper Bv value are used as shown in FIG. 24. In the example of FIG. 15, the proper Bv value becomes maximum in the sky region and becomes minimum in the person region. Thus, the difference ΔBv is calculated by subtracting the proper Bv value Bv_HUMAN for the person region (also called the human region) from the proper Bv value Bv_SKY for the sky region.

The gain amount to be multiplied to the image becomes small with the decrease of the difference ΔBv, and the degree of degradation of image quality due to execution of the single image-based processing becomes small. If the difference ΔBv is smaller than a predetermined threshold value TH_ΔBv as shown in FIG. 24, the single image-based processing is performed.

The degree of influence of an occlusion region, which is generated in a synthesized image due to execution of the plural images-based processing, upon image quality becomes small with decrease of the amount of person's movement. If, as shown in FIG. 24, the difference ΔBv is larger than the predetermined threshold value TH_ΔBv and if the amount of person's movement is smaller than a predetermined threshold value TH_MV, the plural images-based processing is performed.

If the difference ΔBv is larger than the predetermined threshold value TH_ΔBv and if the amount of person's movement is larger than the predetermined threshold value TH_MV, the single image-based processing is performed as shown in FIG. 24 using the low-noise priority method described in the second embodiment. By executing the single image-based processing, an occlusion region can be prevented from being generated, and by using the low-noise priority method, an image can be prevented from being multiplied with a gain amount larger than an allowable amount, whereby the image quality can be improved.

As described above, which of the plural images-based processing or the single image-based processing is to be performed is determined by the processing type determination unit 2005.

If the processing type determination unit 2005 determines that the plural images-based processing is to be performed, the plural images-based processing unit 2006 performs the plural images-based processing (which is the same as the processing performed by the units from the main object region decision unit 205 to the image synthesis unit 211 of the image processing apparatus 200 of the first embodiment), thereby synthesizing plural images into a synthesized image and outputting the synthesized image as an output image.

On the other hand, if the processing type determination unit 2005 determines that the single image-based processing is to be performed, the single image-based processing unit 2007 performs the single image-based processing (which is the same as the processing performed by the units from the exposure/gain calculation unit 1205 to the signal processing unit 1208 of the image processing apparatus of the second embodiment), thereby generating and outputting an output image.

The output image generated by and output from either the plural images-based processing unit 2006 or the single image-based processing unit 2007 is supplied to the image display unit 2008 and to the image storage unit 2009.

As described above, according to this embodiment, which of the plural images-based processing or the single image-based processing is to be performed is determined based on the difference ΔBv between reference Bv values for image regions and based on the amount of person's movement. It is therefore possible to generate the output image while enjoying the advantages of both the plural images-based processing and the single image-based processing, whereby the quality of the output image can be improved.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-022309, filed Feb. 7, 2013, which is hereby incorporated by reference herein in its entirety.

What is claimed is:

1. An image pickup apparatus that acquires a plurality of images for use in generating a synthesized image, comprising:
a region determination unit configured to determine a plurality of object regions based on image data;
a calculation unit configured to calculate representative brightness values of respective regions of the plurality of object regions determined by the region determination unit;
a first decision unit configured to decide a first exposure condition based on the representative brightness value of a first object region calculated by the calculation unit, wherein the first object region is a main object region;
a second decision unit configured to decide a second exposure condition based on the representative brightness value of the first object region and the representative brightness value of a second object region not including the first object region that are calculated by the calculation unit, wherein the second exposure condition differs from the first exposure condition; and
an image acquisition unit configured to acquire a plurality of images by using the first and second exposure conditions.

2. The image pickup apparatus according to claim 1, wherein the second decision unit decides the second exposure condition such that the representative brightness value of the second object region in an image acquired by using the second exposure condition becomes different from the representative brightness value of the first object region in an image acquired by using the first exposure condition.

3. The image pickup apparatus according to claim 1, wherein in a case that the representative brightness value of the second object region calculated by the calculation unit is larger than the representative brightness value of the first object region, the second decision unit decides the second exposure condition such that the representative brightness value of the second object region in an image acquired by using the second exposure condition becomes larger than the representative brightness value of the first object region in an image acquired by using the first exposure condition.

4. The image pickup apparatus according to claim 1, wherein in a case where the representative brightness value of the second object region calculated by the calculation unit is smaller than the representative brightness value of the first object region, the second decision unit decides the second exposure condition such that the representative brightness value of the second object region in an image acquired by using the second exposure condition becomes smaller than the representative brightness value of the first object region in an image acquired by using the first exposure condition.

5. The image pickup apparatus according to claim 1, wherein in a case where the representative brightness value of the second object region calculated by the calculation unit is larger than the representative brightness value of the first object region, the second decision unit decides the second exposure condition such that an exposure of the second exposure condition becomes an underexposure for the representative brightness value of the first object region calculated by the calculation unit and becomes an overexposure for the representative brightness value of the second object region calculated by the calculation unit.

6. The image pickup apparatus according to claim 1, wherein in a case where the representative brightness value of the second object region calculated by the calculation unit is smaller than the representative brightness value of the first object region, the second decision unit decides the second exposure condition such that an exposure of the second exposure condition becomes an overexposure for the representative brightness value of the first object region calculated by the calculation unit and becomes an underexposure for the representative brightness value of the second object region calculated by the calculation unit.

7. The image pickup apparatus according to claim 1, wherein the first decision unit decides the first exposure condition such that an exposure of the first exposure condition becomes a target exposure for the representative brightness value of the first object region.

8. The image pickup apparatus according to claim 1, further including:
a generation unit configured to generate a synthesized image by using the plurality of images acquired by the image acquisition unit,
wherein the generation unit uses, for the first object region, an image acquired by using the first exposure condition, and uses, for the second object region, an image acquired by using the second exposure condition.

9. The image pickup apparatus according to claim 1, further including:
a region decision unit configured to decide the main object region from among the plurality of object regions determined by the region determination unit,
wherein the region decision unit calculates evaluation values of respective ones of the plurality of object regions according to sizes of the object regions, and decides the main object region based on the calculated evaluation values.

10. The image pickup apparatus according to claim 9, wherein the region decision unit calculates the evaluation values of respective ones of the plurality of object regions by multiplying the sizes of the plurality of object regions respectively by coefficients given according to types of the object regions.

11. The image pickup apparatus according to claim 10, wherein the region decision unit changes the coefficients according to a photographic scene.

12. The image pickup apparatus according to claim 10, wherein the region decision unit determines, as the main object region, one region that has a largest evaluation value among the plurality of object regions.

13. An image processing apparatus that acquires a plurality of images for use in generating a synthesized image, comprising:
a region determination unit configured to determine a plurality of object regions based on image data;
a calculation unit configured to calculate representative brightness values of respective ones of the plurality of object regions determined by the region determination unit;
a gain decision unit configured to decide a gain for a reference image based on the representative brightness value of a first object region and the representative brightness value of a second object region different from the first object region that are calculated by the calculation unit; and
an image acquisition unit configured to acquire, by using the gain decided by the gain decision unit, images for use in generating a synthesized image.

14. The image processing apparatus according to claim 13, further including:
a region decision unit configured to decide on a reference object region from among the plurality of object regions determined by the region determination unit,
wherein the gain decision unit sets as the first object region the reference object region decided by the region decision unit, and decides the gain.

15. The image processing apparatus according to claim 14, wherein the region decision unit calculates evaluation values of respective ones of the plurality of object regions according to sizes of the object regions, and decides the reference object region based on the calculated evaluation values.

16. The image processing apparatus according to claim 14, wherein the region decision unit decides the reference object region based on proper brightness values set for respective ones of the plurality of object regions.

17. An image pickup apparatus that acquires a plurality of images for use in generating a synthesized image, comprising:
a region determination unit configured to determine a plurality of object regions based on image data;
a calculation unit configured to calculate representative brightness values of respective ones of the plurality of object regions determined by the region determination unit; and
a control unit configured, based on the representative brightness value of a first object region and the representative brightness value of a second object region not including the first object region that are calculated by the calculation unit, to switch between first control where a plurality of images are acquired by using a plurality of exposure conditions and second control where a plurality of images are acquired by applying different gains to a reference image.

18. A control method for an image pickup apparatus that acquires a plurality of images for use in generating a synthesized image, comprising:
determining a plurality of object regions based on image data;
calculating representative brightness values of respective ones of the plurality of determined object regions;
deciding a first exposure condition based on the representative brightness value of a calculated first object region, wherein the first object region is a main object region;
deciding a second exposure condition based on the calculated representative brightness value of the first object region and the calculated representative brightness value of a second object region not including the first object region, wherein the second exposure condition differs from the first exposure condition; and
acquiring a plurality of images by using the first and second exposure conditions.

19. An image processing method that acquires a plurality of images for use in generating a synthesized image, comprising:
determining a plurality of object regions based on image data;
calculating representative brightness values of respective regions of the determined plurality of object regions;
deciding a gain for a reference image based on the calculated representative brightness value of a first object region and the calculated representative brightness value of a second object region different from the first object region; and
acquiring, by using the decided gain, images for use in generating a synthesized image.

20. A control method for an image pickup apparatus that acquires a plurality of images for use in generating a synthesized image, comprising:
determining a plurality of object regions based on image data;
calculating representative brightness values of respective regions of the plurality of determined object regions; and
based on the calculated representative brightness value of a first object region and the calculated representative brightness value of a second object region not including the first object region, switching between first control where a plurality of images are acquired by using a plurality of exposure conditions and second control where a plurality of images are acquired by applying different gains to a reference image.
